(19) United States
(12) Patent Application Publication
(10) Pub. No.: US 2010/0145951 A1
(43) Pub. Date: Jun. 10, 2010

(54) METHODS FOR ESTABLISHING LEGITIMACY OF COMMUNICATIONS

(76) Inventors: Mark F. Van Coeverden De Groot, Montreal (CA); John D. Swain, Boston, MA (US)

Correspondence Address: BARNES & THORNBURG LLP, 11 SOUTH MERIDIAN, INDIANAPOLIS, IN, 46204, US

(21) Appl. No.: 12/522,500

(22) PCT Filed: Jan. 8, 2008
(86) PCT No.: PCT/CA08/00025

§ 371 Date: Jan. 12, 2010

(30) Foreign Application Priority Data
Jan. 8, 2007 (CA) 2,574,439

(51) Int. Cl. G06F 15/16; G06F 17/30

(52) U.S. Cl. 707/747; 709/206; 707/E17.002

(57) ABSTRACT

A method for sending a message to a recipient, which comprises determining a data set associated with the message; accessing an ensemble of precomputed tags corresponding to respective initial data sets, each precomputed tag representing a solution to a computational problem involving the respective initial data set; identifying the precomputed tag in the ensemble for which the corresponding initial data set corresponds to the data set associated with the message; and sending the message and informing the recipient of the identified precomputed tag. The recipient executes a method comprising obtaining a tag associated with the message; determining a data set associated with the message, the data set in some embodiments including a portion extrinsic to the message; determining whether the tag represents a solution to a computational problem involving the data set associated with the message; determining whether the tag was specifically generated for the message, based on the portion extrinsic to the message; and establishing the legitimacy of the message based on the outcomes of the previous steps.

### CROSS-REFERENCE TO RELATED APPLICATION

The present application is a continuation-in-part of U.S. patent application Ser. No. 11/572,042 to Swain et al., assigned to LegiTime Technologies Inc., hereby incorporated by reference herein.

### FIELD OF THE INVENTION

The present invention relates generally to communications and, more particularly, to methods and systems for establishing the legitimacy of communications.

### BACKGROUND

Unsolicited communication, commonly called “junk mail”, “junk messages”, “junk communications” or “spam”, is a difficult concept to define precisely because the value or interest of a message from a sender to a recipient cannot, in general, be predicted by a third party. Indeed, in many cases it is not even easy for the sender himself (herself) to estimate the value or interest of the message to the recipient (who may be a potential customer, for example) nor would it necessarily be easy for recipient to estimate the value or interest of the message without actually reading it, or at least some part of it.

Once these facts are accepted, it is clear that conventional spam control techniques, which make conclusions about incoming messages based solely on addresses, words and expressions therein, are deficient. Specifically, the use of key words, heuristics, Bayesian filters and the like will overlook carefully crafted junk messages that introduce elements of randomness or unpredictability or insert elements which are designed to give the appearance of being legitimate communications. On the other hand, by setting conventional filters to behave in a highly restrictive fashion, one increases the incidence of “false positives”, which is the phenomenon whereby a message that contains certain earmarks of an unsolicited communication (e.g., key words or hyperlinks), but is actually a legitimate message, will be discarded by the filter instead of being delivered to the intended recipient.

Clearly, therefore, the industry is in need of an alternate solution to countering the incidence of junk messages.

### SUMMARY OF THE INVENTION

A first broad aspect of the present invention seeks to provide a method for sending a message to a recipient, comprising:
determining a data set associated with the message;
accessing an ensemble of precomputed tags corresponding to respective initial data sets, each precomputed tag representing a solution to a computational problem involving the respective initial data set;
identifying the precomputed tag in said ensemble for which the corresponding initial data set corresponds to the data set associated with the message; and
sending the message and informing the recipient of the identified precomputed tag.

A second broad aspect of the present invention seeks to provide an apparatus for sending a message to a recipient, comprising:
means for determining a data set associated with the message;
means for accessing an ensemble of precomputed tags corresponding to respective initial data sets, each precomputed tag representing a solution to a computational problem involving the respective initial data set;
means for identifying the precomputed tag in said ensemble for which the corresponding initial data set corresponds to the data set associated with the message; and
means for sending the message and informing the recipient of the identified precomputed tag.

A third broad aspect of the present invention seeks to provide a computer-readable medium comprising computer-readable program code which, when interpreted by a computing apparatus, causes the computing apparatus to execute a method for sending a message to a recipient, the computer-readable program code comprising:
first computer-readable program code for causing the computing apparatus to determine a data set associated with the message;
second computer-readable program code for causing the computing apparatus to access an ensemble of precomputed tags corresponding to respective initial data sets, each precomputed tag representing a solution to a computational problem involving the respective initial data set;
third computer-readable program code for causing the computing apparatus to identify the precomputed tag in said ensemble for which the corresponding initial data set corresponds to the data set associated with the message; and
fourth computer-readable program code for causing the computing apparatus to send the message and inform the recipient of the identified precomputed tag.

In the above, a “precomputed” tag may refer to a tag which can be computed (at least in part) before the creation of the message to which it will be attached, and may be defined in such a manner that the recipient of a message with this tag attached can, either with complete certainty or with a high degree of certainty depending on the embodiment, be confident that this tag has not been used for some other message.

A fourth broad aspect of the present invention seeks to provide a method for assessing legitimacy of a received message, comprising:
obtaining a tag associated with the message;
determining a data set associated with the message, the data set including a portion extrinsic to the message;
determining whether the tag represents a solution to a computational problem involving the data set associated with the message;
determining whether the tag was specifically generated for the message, based on the portion extrinsic to the message; —establishing a legitimacy of the message based on the outcomes of c) and d).

A fifth broad aspect of the present invention seeks to provide an apparatus for assessing legitimacy of a received message, comprising:
means for obtaining a tag associated with the message;
means for determining a data set associated with the message, the data set including a portion extrinsic to the message;
means for determining whether the tag represents a solution to a computational problem involving the data set associated with the message;
means for determining whether the tag was specifically generated for the message, based on the portion extrinsic to the message; and
means for establishing a legitimacy of the message based on whether the tag was found to represent a solution to a computational problem involving the data set associated with the message and on whether the tag was found to have been specifically generated for the message.

A sixth broad aspect of the present invention seeks to provide a computer-readable medium comprising computer-readable program code which, when interpreted by a computing apparatus, causes the computing apparatus to execute a method for assessing legitimacy of a received message, the computer-readable program code comprising:
first computer-readable program code for causing the computing apparatus to obtain a tag associated with the message;
second computer-readable program code for causing the computing apparatus to determine a data set associated with the message, the data set including a portion extrinsic to the message;
third computer-readable program code for causing the computing apparatus to determine whether the tag represents a solution to a computational problem involving the data set associated with the message;
fourth computer-readable program code for causing the computing apparatus to determine whether the tag was specifically generated for the message, based on the portion extrinsic to the message; and
fifth computer-readable program code for causing the computing apparatus to establish a legitimacy of the message based on whether the tag was found to represent a solution to a computational problem involving the data set associated with the message and on whether the tag was found to have been specifically generated for the message.

A seventh broad aspect of the present invention seeks to provide a method for progressively sending a message to a recipient, comprising:
solving a first computational problem involving a first message portion, thereby to produce a first tag;
solving a second computational problem involving a second message portion that includes information that was not yet in existence when said solving the first computational problem was begun, thereby to produce a second tag;
transmitting the first message portion to the recipient and informing the recipient of the first tag; and
transmitting the second message portion to the recipient and informing the recipient of the second tag.

The above process may be iterated any desired number of times.

An eighth broad aspect of the present invention seeks to provide an apparatus for progressively sending a message to a recipient, comprising:
means for solving a first computational problem involving a first message portion, thereby to produce a first tag;
means for solving a second computational problem involving a second message portion, that includes information that was not yet in existence when said solving the first computational problem was begun, thereby to produce a second tag;
means for transmitting the first message portion to the recipient and informing the recipient of the first tag; and
means for transmitting the second message portion to the recipient and informing the recipient of the second tag.

A ninth broad aspect of the present invention seeks to provide a computer-readable medium comprising computer-readable program code which, when interpreted by a computing apparatus, causes the computing apparatus to execute a method for progressively sending a message to a recipient, the computer-readable program code comprising:
first computer-readable program code for causing the computing apparatus to solve a first computational problem involving a first message portion, thereby to produce a first tag;
second computer-readable program code for causing the computing apparatus to solve a second computational problem involving a second message portion, that includes information that was not yet in existence when said solving the first computational problem was begun, thereby to produce a second tag;
third computer-readable program code for causing the computing apparatus to transmit the first message portion to the recipient and informing the recipient of the first tag; and
fourth computer-readable program code for causing the computing apparatus to transmit the second message portion to the recipient and informing the recipient of the second tag.

A tenth broad aspect of the present invention seeks to provide a method implemented by a search entity, comprising:
formulating a request based on an actual or prospective search query;
issuing the request to a set of potential authorities to identify a subset of candidate authorities, wherein a candidate authority corresponds to a potential authority that positively responds to the request by supplying a data element and a tag in association with the data element;
establishing legitimacy of the data element received from a given candidate authority based on whether the tag received in association with the data element represents a solution to a computational problem involving the data element; and
presenting a results set to a client having issued an actual search query, corresponding to the actual or prospective search query on which the request was based, the results set conveying those data elements deemed legitimate.

The data elements deemed legitimate could be conveyed by, for example, presenting only those data elements deemed legitimate or presenting them in such a manner which privileges those results, data elements deemed legitimate within an overall results set that includes both legitimate and non-legitimate data elements.

An eleventh broad aspect of the present invention seeks to provide a search entity, comprising:
means for formulating a request based on an actual or prospective search query;
means for issuing the request to a set of potential authorities to identify a subset of candidate authorities, wherein a candidate authority corresponds to a potential authority that positively responds to the request by supplying a data element and a tag in association with the data element;
means for establishing legitimacy of the data element received from a given candidate authority based on whether the tag received in association with the data element represents a solution to a computational problem involving the data element; and
means for presenting a results set to a client having issued an actual search query corresponding to the actual or prospective search query on which the request was based, the results set conveying those data elements deemed legitimate.

The data elements deemed legitimate could be conveyed by, for example, presenting only those data elements deemed legitimate or presenting them in such a manner which privileges those results data elements deemed legitimate within an overall results set that includes both legitimate and non-legitimate data elements.

A twelfth broad aspect of the present invention seeks to provide a computer-readable medium comprising computer-readable program code which, when interpreted by a search entity, causes the search entity to execute a method, the computer-readable program code comprising:
first computer-readable program code for causing the search entity to formulate a request based on an actual or prospective search query;
second computer-readable program code for causing the search entity to issue the request to a set of potential authorities to identify a subset of candidate authorities, wherein a candidate authority corresponds to a potential authority that positively responds to the request by supplying a data element and a tag in association with the data element;
third computer-readable program code for causing the search entity to establish legitimacy of the data element received from a given candidate authority based on whether the tag received in association with the data element represents a solution to a computational problem involving the data element; and
fourth computer-readable program code for causing the search entity to present a results set to a client having issued an actual search query corresponding to the actual or prospective search query on which the request was based, the results set conveying those data elements deemed legitimate.

The data elements deemed legitimate could be conveyed by, for example, presenting only those data elements deemed legitimate or presenting them in such a manner which privileges those results data elements deemed legitimate within an overall results set that includes both legitimate and non-legitimate data elements.

A thirteenth broad aspect of the present invention seeks to provide a method implemented by a website, comprising:
receiving a query from a client over a network;
issuing a response to the client, the response including online content;
being attentive to receipt of a tag from the client;
establishing a legitimacy of the query based on whether the tag received from the client represents a solution to a computational problem involving a portion of the online content; and
maintaining information on the legitimacy of the query and other queries to which responses including the online content were issued, for conveyance to a third party as evidence of legitimacy of client interest in the online content.

A fourteenth broad aspect of the present invention seeks to provide an apparatus hosting a web site, comprising:
means for receiving a query from a client over a network;
means for issuing a response to the client, the response including online content;
means for being attentive to receipt of a tag from the client;
means for establishing a legitimacy of the query based on whether the tag received from the client represents a solution to a computational problem involving a portion of the online content; and
means for maintaining information on the legitimacy of the query and other queries to which responses including the online content were issued, for conveyance to a third party as evidence of legitimacy of client interest in the online content.

A fifteenth broad aspect of the present invention seeks to provide a computer-readable medium comprising computer-readable program code which, when interpreted by a web site, causes the search entity to execute a method, the computer-readable program code comprising:
first computer-readable program code for causing the web site to be attentive to receipt of a query from a client over a network;
second computer-readable program code for causing the web site to issue a response to the client, the response including online content;
third computer-readable program code for causing the web site to being attentive to receipt of a tag from the client;
fourth computer-readable program code for causing the web site to establish a legitimacy of the query based on whether the tag received from the client represents a solution to a computational problem involving a portion of the online content; and
fifth computer-readable program code for causing the web site to maintain information on the legitimacy of the query and other queries to which responses including the online content were issued, for conveyance to a third party as evidence of legitimacy of client interest in the online content.

A sixteenth broad aspect of the present invention seeks to provide a method implemented by a prospective sender of a message to a recipient, comprising:
obtaining compound address data derived from a plurality of sets of coordinates where the recipient can potentially be reached;
solving a computational problem involving the compound address data, thereby to produce a tag representing a solution to the computational problem;
formulating the message for transmission to a first one of the plurality of sets of coordinates;
formulating the message for transmission to a second one of the plurality of sets of coordinates different from the first one of the plurality of sets of coordinates; and
transmitting the tag to the second party.

A seventeenth broad aspect of the present invention seeks to provide an apparatus for transmission of a message to a recipient, comprising:
means for obtaining compound address data derived from a plurality of sets of coordinates where the recipient can potentially be reached;
means for solving a computational problem involving the compound address data, thereby to produce a tag representing a solution to the computational problem;
means for formulating the message for transmission to a first one of the plurality of sets of coordinates;
means for formulating the message for transmission to a second one of the plurality of sets of coordinates different from the first one of the plurality of sets of coordinates; and
means for transmitting the tag to the second party.

An eighteenth broad aspect of the present invention seeks to provide a computer-readable medium comprising computer-readable program code which, when interpreted by a computing apparatus, causes the computing apparatus to execute a method of transmitting a message to a recipient, the computer-readable program code comprising:
first computer-readable program code for causing the computing apparatus to obtain compound address data derived from a plurality of sets of coordinates where the recipient can potentially be reached;
second computer-readable program code for causing the computing apparatus to solve a computational problem involving the compound address data, thereby to produce a tag representing a solution to the computational problem;
third computer-readable program code for causing the computing apparatus to formulate the message for transmission to a first one of the plurality of sets of coordinates;
fourth computer-readable program code for causing the computing apparatus to formulate the message for transmission to a second one of the plurality of sets of coordinates different from the first one of the plurality of sets of coordinates; and
fifth computer-readable program code for causing the computing apparatus to transmit the tag to the second party.

A nineteenth broad aspect of the present invention seeks to provide a method implemented by a recipient that is reachable at a plurality of sets of coordinates, comprising:
receiving a message sent to a first one of the plurality of sets of coordinates;
obtaining a tag associated with the message; and
establishing a legitimacy of the message based on whether the tag represents a solution to a computational problem involving compound address data derived from a plurality of sets of coordinates.

A twentieth broad aspect of the present invention seeks to provide an apparatus reachable at a plurality of sets of coordinates, comprising:
means for receiving a message sent to a first one of the plurality of sets of coordinates;
means for obtaining a tag associated with the message; and
means for establishing a legitimacy of the message based on whether the tag represents a solution to a computational problem involving compound address data derived from a plurality of sets of coordinates.

A twenty-first broad aspect of the present invention seeks to provide a computer-readable medium comprising computer-readable program code which, when interpreted by a computing apparatus that is reachable at a plurality of sets of coordinates, causes the computing apparatus to execute a method, the computer-readable program code comprising:
first computer-readable program code for causing the computing apparatus to be attentive to receipt a message sent to a first one of the plurality of sets of coordinates;
second computer-readable program code for causing the computing apparatus to obtain a tag associated with the message; and
third computer-readable program code for causing the computing apparatus to establish a legitimacy of the message based on whether the tag represents a solution to a computational problem involving compound address data derived from a plurality of sets of coordinates.

A twenty-second broad aspect of the present invention seeks to provide a method implemented by a first party that has been designated by a second party as a preferred sender of messages to the second party, comprising:
receiving a preferred sender key;
determining a data set associated with a message to be sent to the second party;
solving a computational problem involving the preferred sender key and the data set associated with the message, thereby to produce a tag representative of a solution to the computational problem; and
transmitting the message to the second party and informing the second party of the tag.

A twenty-third broad aspect of the present invention seeks to provide an apparatus associated with a first party that has been designated by a second party as a preferred sender of messages to the second party, said apparatus comprising:
means for receiving a preferred sender key;
means for determining a data set associated with a message to be sent to the second party;
means for solving a computational problem involving the preferred sender key and the data set associated with the message, thereby to produce a tag representative of a solution to the computational problem; and
means for transmitting the message to the second party and informing the second party of the tag.

A twenty-fourth broad aspect of the present invention seeks to provide a computer-readable medium comprising computer-readable program code which, when interpreted by a computing apparatus that is associated with a first party that has been designated by a second party as a preferred sender of messages to the second party, causes the computing apparatus to execute a method, the computer-readable program code comprising:
first computer-readable program code for causing the computing apparatus to be attentive to receipt of a preferred sender key;
second computer-readable program code for causing the computing apparatus to determine a data set associated with a message to be sent to the second party;
third computer-readable program code for causing the computing apparatus to solve a computational problem involving the preferred sender key and the data set associated with the message, thereby to produce a tag representative of a solution to the computational problem; and
fourth computer-readable program code for causing the computing apparatus to transmit the message to the second party and informing the second party of the tag.

A twenty-fifth broad aspect of the present invention seeks to provide a method implemented by a first party for which a second party has been designated as a preferred sender of messages to the first party, comprising:
maintaining a preferred sender key;
sending the preferred sender key to the second party;
receiving a message from the second party;
obtaining a tag associated with the message; and
establishing a legitimacy of the message based on whether the tag represents a solution to a computational problem involving the preferred sender key.

A twenty-sixth broad aspect of the present invention seeks to provide an apparatus associated with a first party for which a second party has been designated as a preferred sender of messages to the first party, said apparatus comprising:
means for maintaining a preferred sender key;
means for sending the preferred sender key to the second party;
means for receiving a message from the second party;
means for obtaining a tag associated with the message; and
means for establishing a legitimacy of the message based on whether the tag represents a solution to a computational problem involving the preferred sender key.

A twenty-seventh broad aspect of the present invention seeks to provide a computer-readable medium comprising computer-readable program code which, when interpreted by a computing apparatus that is associated with a first party for which a second party has been designated as a preferred sender of messages to the first party, causes the computing apparatus to execute a method, the computer-readable program code comprising:
first computer-readable program code for causing the computing apparatus to maintain a preferred sender key;
second computer-readable program code for causing the computing apparatus to send the preferred sender key to the second party;
third computer-readable program code for causing the computing apparatus to be attentive to receipt of a message from the second party;
fourth computer-readable program code for causing the computing apparatus to obtain a tag associated with the message; and
fifth computer-readable program code for causing the computing apparatus to establish a legitimacy of the message based on whether the tag represents a solution to a computational problem involving the preferred sender key.

A twenty-eighth broad aspect of the present invention seeks to provide a method implemented by a prospective sender of a message to a recipient, comprising:
determining a data set associated with the message;
partially factorizing a numerical representation of the data set in an attempt to produce at least one prime factor larger than a certain minimum threshold (“large prime factor”), wherein a quotient of the numerical representation and the at least one large prime factor is factorizable into at least one prime factor larger than any of the at least one large prime factor; transmitting the message and the at least one large prime factor to the recipient; and omitting transmission of the at least one prime factor larger than any of the at least one large prime factor.

A twenty-ninth broad aspect of the present invention seeks to provide an apparatus associated with a prospective sender of a message to a recipient, said apparatus comprising:
means for determining a data set associated with the message;
means for partially factorizing a numerical representation of the data set in an attempt to produce at least one large prime factor, wherein a quotient of the numerical representation and the at least one large prime factor is deemed to be factorizable into at least one prime factor larger than any of the at least one large prime factor;
means for transmitting the message and the at least one large prime factor to the recipient; and
means for omitting transmission of the at least one prime factor larger than any of the at least one large prime factor.

A thirtieth broad aspect of the present invention seeks to provide a computer-readable medium comprising computer-readable program code which, when interpreted by a computing apparatus that is associated with a prospective sender of a message to a recipient, causes the computing apparatus to execute a method, the computer-readable program code comprising:
first computer-readable program code for causing the computing apparatus to determine a data set associated with the message;
second computer-readable program code for causing the computing apparatus to partially factorize a numerical representation of the data set in an attempt to produce at least one large prime factor, wherein a quotient of the numerical representation and the at least one large prime factor is deemed to be factorizable into at least one prime factor larger than any of the at least one large prime factor;
third computer-readable program code for causing the computing apparatus to transmit the message and the at least one large prime factor to the recipient; and
fourth computer-readable program code for causing the computing apparatus to omit transmission of the at least one prime factor larger than any of the at least one large prime factor.

A thirty-first broad aspect of the present invention seeks to provide a method implemented by a prospective sender of a message to a recipient, comprising:
deriving a data set from the message;
factorizing a numerical representation of the data set, thereby to produce a plurality of factors;
transmitting the message and one or more of the factors to the recipient; and
withholding at least one factor in said subset from the recipient.

A thirty-second broad aspect of the present invention seeks to provide an apparatus associated with a prospective sender of a message to a recipient, said apparatus comprising:
means for deriving a data set from the message;
means for factorizing a numerical representation of the data set, thereby to produce a plurality of factors;
means for transmitting the message and one or more of the factors to the recipient; and
means for withholding at least one factor in said subset from the recipient.

A thirty-third broad aspect of the present invention seeks to provide a computer-readable medium comprising computer-readable program code which, when interpreted by a computing apparatus that is associated with a prospective sender of a message to a recipient, causes the computing apparatus to execute a method, the computer-readable program code comprising:
first computer-readable program code for causing the computing apparatus to derive a data set from the message;
second computer-readable program code for causing the computing apparatus to factorize a numerical representation of the data set, thereby to produce a plurality of factors;
third computer-readable program code for causing the computing apparatus to transmit the message and one or more of the factors to the recipient; and
fourth computer-readable program code for causing the computing apparatus to withhold at least one factor in said subset from the recipient.

A thirty-fourth broad aspect of the present invention seeks to provide a method implemented by a prospective sender of a message to a recipient, comprising:
deriving a data set from the message;
factorizing a numerical representation of the data set, thereby to produce a plurality of factors;
truncating at least one of the factors, thereby to produce at least one truncated factor; and
transmitting the message and the at least one truncated factor to the recipient.

A thirty-fifth broad aspect of the present invention seeks to provide an apparatus associated with a prospective sender of a message to a recipient, said apparatus comprising:
means for deriving a data set from the message;
means for factorizing a numerical representation of the data set, thereby to produce a plurality of factors;
means for truncating at least one of the factors, thereby to produce at least one truncated factor; and
means for transmitting the message and the at least one truncated factor to the recipient.

A thirty-sixth broad aspect of the present invention seeks to provide a computer-readable medium comprising computer-readable program code which, when interpreted by a computing apparatus that is associated with a prospective sender of a message to a recipient, causes the computing apparatus to execute a method, the computer-readable program code comprising:
first computer-readable program code for causing the computing apparatus to derive a data set from the message;
second computer-readable program code for causing the computing apparatus to factorize a numerical representation of the data set, thereby to produce a plurality of factors;
third computer-readable program code for causing the computing apparatus to truncate at least one of the factors, thereby to produce at least one truncated factor; and
fourth computer-readable program code for causing the computing apparatus to transmit the message and the at least one truncated factor to the recipient.

A thirty-seventh broad aspect of the present invention seeks to provide a method implemented by a prospective sender of a message to a recipient, comprising:
selecting a hash function;
co-opting a field of the message to include an indication of the selected hash function;
applying the selected hash function to the message with the co-opted field in order to derive a hash value;
evaluating a computational function of the hash value, thereby to produce a tag representing a result of the computational function;
transmitting the message with the co-opted field to the recipient; and
transmitting the tag to the recipient.

A thirty-eighth broad aspect of the present invention seeks to provide an apparatus associated with a prospective sender of a message to a recipient, said apparatus comprising:
means for selecting a hash function;
means for co-opting a field of the message to include an indication of the selected hash function;
means for applying the selected hash function to the message with the co-opted field in order to derive a hash value;
means for evaluating a computational function of the hash value, thereby to produce a tag representing a result of the computational function;
means for transmitting the message with the co-opted field to the recipient; and
means for transmitting the tag to the recipient.

A thirty-ninth broad aspect of the present invention seeks to provide a computer-readable medium comprising computer-readable program code which, when interpreted by a computing apparatus that is associated with a prospective sender of a message to a recipient, causes the computing apparatus to execute a method, the computer-readable program code comprising:
first computer-readable program code for causing the computing apparatus to select a hash function;
second computer-readable program code for causing the computing apparatus to co-opt a field of the message to include an indication of the selected hash function;
third computer-readable program code for causing the computing apparatus to apply the selected hash function to the message with the co-opted field in order to derive a hash value;
fourth computer-readable program code for causing the computing apparatus to evaluate a computational function of the hash value, thereby to produce a tag representing a result of the computational function;
fifth computer-readable program code for causing the computing apparatus to transmit the message with the co-opted field to the recipient; and
sixth computer-readable program code for causing the computing apparatus to transmit the tag to the recipient.

These and other aspects and features of the present invention will now become apparent to those of ordinary skill in the art upon review of the following description of specific embodiments of the invention in conjunction with the accompanying drawings.

### BRIEF DESCRIPTION OF THE DRAWINGS

In the accompanying drawings:

FIG. 1 is a block diagram illustrating transmission of a tagged message from a sender to a receiver, in accordance with a first non-limiting embodiment of the present invention;

FIG. 2 depicts generation of a tag to be combined with an original message, thereby to create a tagged message, in accordance with a non-limiting embodiment of the present invention;

FIG. 3A is a block diagram illustrating processing of a tagged message by the receiver of FIG. 1, in accordance with a non-limiting embodiment of the present invention;

FIG. 3B is a block diagram illustrating processing of a tagged message by the receiver of FIG. 1, in accordance with another non-limiting embodiment of the present invention;

FIG. 4 is a block diagram illustrating transmission of a tagged message from a sender to a receiver, in accordance with a second non-limiting embodiment of the present invention;

FIG. 5 is a block diagram that illustrates processing of a search query by a search entity, thereby to produce a results set, in accordance with another non-limiting embodiment of the present invention;

FIG. 6 is a block diagram that shows transmission to a website of a tag generated based on information previously received from the website, in accordance with a non-limiting embodiment of the present invention;

FIG. 7 is a block diagram illustrating transmission of multiple versions of a tagged message from a sender to a receiver that is reachable at a plurality of coordinates in accordance with a non-limiting embodiment of the present invention;

FIG. 8 is a block diagram illustrating transmission of a tagged message from a sender to a receiver, in accordance with a third non-limiting embodiment of the present invention;

FIG. 9A is a block diagram illustrating transmission of a tagged message from a sender to a receiver, in accordance with a fourth non-limiting embodiment of the present invention;

FIG. 9B is a block diagram illustrating transmission of a tagged message from a sender to a receiver, in accordance with a fifth non-limiting embodiment of the present invention; and

FIG. 9C is a block diagram illustrating transmission of a tagged message from a sender to a receiver, in accordance with a sixth non-limiting embodiment of the present invention.

It is to be expressly understood that the description and drawings are only for the purpose of illustration of certain embodiments of the invention and are an aid for understanding. They are not intended to be a definition of the limits of the invention.

### DETAILED DESCRIPTION

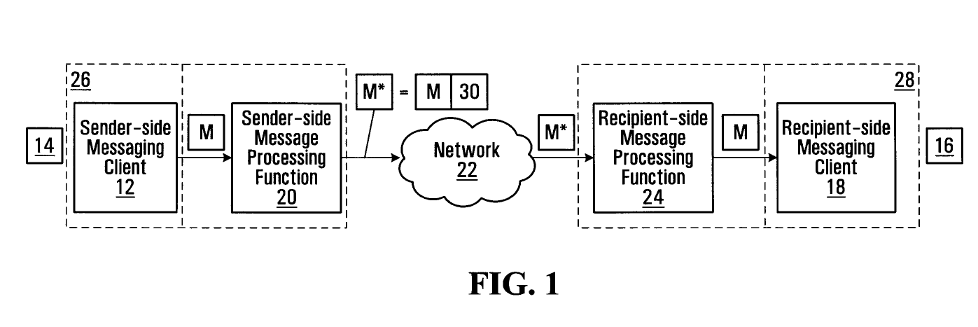

With reference to FIG. 1, a sender-side messaging client 12 generates an original message (hereinafter denoted by the single letter M) on behalf of a sender 14. The original message M is destined for a recipient 16 who uses a recipient-side messaging client 18. In accordance with a non-limiting embodiment of the present invention, the message M is processed by a sender-side message processing function 20, which transforms the original message M into a tagged message M*. The tagged message M* is delivered over a network 22 to a recipient-side message processing function 24, which transforms the tagged message M* back into the original message M for delivery to the recipient-side messaging client 18. In this way, the original message M is conveyed from the sender 14 to the recipient 16.

By way of non-limiting example, the sender-side messaging client 12 may be implemented as a software application executed by a sender-side computing device 26 to which the sender 14 has access via one or more input devices and/or one or more output devices. By way of non-limiting example, the recipient-side messaging client 18 may be implemented as a software application executed by a recipient-side computing device 28 to which the recipient 16 has access via one or more input devices and/or one or more output devices. Non-limiting examples of the sender-side computing device 26 and the recipient-side computing device 28 include a personal computer (including a laptop), a computer server, a mobile telephone, a personal digital assistant and a networked electronic communication device (including portable devices such as Blackberry™).

By way of non-limiting example, the sender-side message processing function 20 can be implemented by a computing entity (e.g., a network server) that processes messages (such as the original message M) on behalf of the sender 14. In some embodiments, the computing entity that implements the sender-side message processing function 20 could be the sender-side computing device 26. In other embodiments, the computing entity that implements the sender-side message processing function 20 could be a separate entity connected to the sender-side computing device 26.

By way of non-limiting example, the recipient-side message processing function 24 can be implemented by a computing entity (e.g., a network server) that processes messages (such as the tagged message M*) on behalf of the recipient 16. In some embodiments, the computing entity that implements the recipient-side message processing function 24 could be the recipient-side computing device 28. In other embodiments, the computing entity that implements the recipient-side message processing function 24 could be a separate entity connected to the recipient-side computing device 28.

By way of non-limiting examples, the network 22 may comprise a local area network, a circuit-switched network (e.g., PSTN), a packet-switched data network (e.g., Internet) or a combination thereof. Still other possibilities exist and are within the scope of the present invention.

The original message M may represent any communication or transfer or data, and in various non-limiting examples may be: an email message; a text or SMS (Short Message Service) message sent via a mobile phone; a video message, an instant message (i.e., a message sent via real time communication systems); a fax message; a portion of a VoIP call, a telemarketing call, a television message (such as a commercial), an instruction or instructions to a target computer such as a web-server; a digital rendition of all or part of a physical communication such as conventional mail including letters, flyers, parcels and so on. In brief, the original message M can represent any information or communication sent by any electronic system for transmitting text, audio, video, graphics and/or other data.

As stated above, the sender-side message processing function 20 transforms the original message M into the tagged message M*. This can performed by execution of a process that involves solving a computational problem involving a data set associated with the original message M. As will be seen, in some embodiments, solving the computational problem may occur in real time based on a data set determined from the original message M or a portion of the original message M. By “real time” here we mean the general sense of “about or close (in some sense) to the time the communication is made or initiated”, with the sense being set by the context and requirements of the given application. In other embodiments, solving the computational problem may occur in a precomputed fashion based on an initial data set in anticipation of the determining of a data set from the original message M or a portion of the original message M. Once the computational problem is solved, the solution can be expressed as a tag 30, and the tag 30 may be appended to the original message M to create the tagged message M*.

By solving the computational problem using, say, CPU cycles of the sender-side message processing function 20, the sender 14 can demonstrate seriousness of his/her intent to the send the original message M to the recipient 16. This “demonstration of legitimacy” can be embodied in the form of the tag 30.

The computational problem has a definition, i.e., it is described in a certain way. In a practical but non-limiting example, the computational problem could be factorization of a number into its prime factors and therefore the definition of this particular computational problem could be “factorize the number in question into its prime factors”, where the “number in question” could be a numerical representation of the original message M (or a portion thereof). The numerical representation could be obtained by converting characters in the original message M into their ASCII code representation, which are then concatenated in their binary or decimal forms.

A class of computational function that may be suitable includes “one-way function” as used in cryptography, number theory and elsewhere. In general terms, a one-way function is a function that is difficult to compute in one direction but easy to compute in the inverse direction. As one description of one-way functions, without limitation, one has the following definition taken from Handbook of Applied Cryptography, by A. Menezes, P. van Oorschot, and S. Vanstone, CRC Press, 1996, page 8 (which actually refers to the inverse of a one-way function as used throughout this specification and thus is capitalized):
Definition 1.12 A function f from a set X to a set Y is called a ONE-WAY FUNCTION if f(x) is “easy” to compute for all xεX but for “essentially all” elements yεIm(f)[or Image[f]] it is “computationally infeasible” to find any xεX such that f(x)=y.
1.13 Note (clarification of terms in Definition 1.12)
(i) A rigorous definition of the terms “easy” and “computationally infeasible” is necessary but would detract from the simple idea that is being conveyed. For the purpose of this chapter [Chapter 1], the intuitive meaning will suffice.
(ii) The phrase “for essentially all elements in Y” refers to the fact that there are a few values yεY for which it is easy to find an xεX such that y=f(x). For example, one may compute y=f(x) for a small number of x values and then for these, the inverse is known by table look-up. An alternate way to describe this property of a ONE-WAY FUNCTION is the following: for a random yεIm(f) it is computationally infeasible to find any xεX such that f(x)=y.

In more intuitive terms, a one-way function as contemplated herein may be exemplified by, although by no means limited to, the factoring of numbers into their prime constituents (prime factors). A subset of such problems is the problem of factoring a product of two or more large prime numbers into its prime factors. That is to say, given two large prime numbers it is a computationally simple task to find their product, while given only their product, finding the primes is generally progressively more computationally intensive as the number to be factored increases in size.

Another example is given by the determination of discrete logarithms. For instance, while a putative solution of the equation 3^{x}=7 mod 13 is easy to verify, it may require significant effort to find a solution, viz., how many times 3 must be multiplied by itself in order that the product leave a remainder of 7 on division by 13. There are many other examples of problems of this kind where the work required to solve them is large compared to the work required to check or validate the putative solution. Throughout this specification, the term “one-way function” is intended for use in its broadest sense, although the prime factoring problem is used as a specific implementation.

As stated above, in some embodiments, solving the computational problem may occur in real time based on a data set determined from the original message M or a portion of the original message M. Conversion of the original message into a numerical representation may without limitation be effected by concatenating the string of bytes representative of the original message M (or relevant portions thereof) into a single value. However, for lengthy messages, this may yield such a high value that execution of the computational function would take an excessive amount of time and becomes impracticable. On the other hand, for very short messages, this technique results in relatively short numbers that are simple to factor into their prime constituents. Therefore, it is within the scope of the present invention to apply a hash function to the original message M so as to ensure, for example, that the numerical result of the hash function will be in a desired range. A hash function is a function which assigns a data item distinguished by some “key” into one of a number of possible “hash buckets” in a hash table. For example a function might act on strings of letters and put each string into one of twenty-six lists depending on the first letter of the string in question.

Any convenient and sufficiently complex hash function can be used. In one example, the hash function ensures that different parts of the original message M (e.g., the portion identifying the recipient, the portion identifying any ancillary data, the message body, etc.) are included in the hash value. It may also be advantageous for the hash function to be “non-local” so that small changes to the original message M (e.g., the portion identifying the recipient) result in changes to the output of the hash function, which changes are difficult to predict. Various existing hash functions satisfy these requirements and can readily be adopted with little or no change for the purposes of certain embodiments of the present invention.

The range of the hash function need not be fixed, nor completely predetermined, nor unique as regards output for all possible messages; it could itself be some function of the various portions of the original message M. A simple example would be to convert the whole message body plus the portion identifying the recipient into a large number (using for example the ASCII code for assigning numerical values to the letters in the Roman alphabet, numbers, control signals, typographic characters and other symbols) and consider the remainder modulo some large prime number, together with some algorithm for ensuring that one obtains n digits (should one choose in a particular implementation to have all output strings be of a specific length n). This example is simplified and purely for illustration. There are many choices which would be apparent to anyone skilled in the art and thus need not be expanded upon here. In any event, the result of the hash function is a number that bears some relationship to the original message M. It can be referred to as a data set associated with the original message M.

In the practical but non-limiting case where the computational problem is indeed factorization of a numerical representation of the original message M (or a portion thereof) into a plurality of prime factors, the tag 30 may correspond to or encode these prime factors.

One can also allow the sender 14 to send as part of the tagged message M*, a demonstration that the factors represented by the tag 30 are indeed prime via a certificate of primality (e.g., a Pratt certificate). For more information regarding primality certificates, the reader is referred to the aforementioned work by Andrew Granville. The reader is also referred to Section 2.5 of Andrew Granville, Bulletin of the American Mathematical Society, Vol 42 (2005), pp. 3-38, incorporated by reference herein. A particular primality certificate based on Fermat's little theorem converse is the Pratt Certificate. For more information regarding the Pratt Certificate in particular, the reader is referred to http://mathworld.wolfram.com/PrattCertificate.html, incorporated by reference herein, from which the following is an excerpt: “Although the general idea had been well-established for some time, Pratt became the first to prove that the certificate tree was of polynomial size and could also be verified in polynomial time. To generate a Pratt certificate, assume that n is a positive integer and {pᵢ} is the set of prime factors of n−1. Suppose there exists an integer x (called a “witness”) such that xⁿ⁻¹≡1(mod n) but x^{e}≢1(mod n) whenever e is one of (n−1)/pᵢ. Then Fermat's little theorem converse states that n is prime (Wagon 1991, pp. 278-279). By applying Fermat's little theorem converse to n and recursively to each purported factor of n−1, a certificate for a given prime number can be generated. Stated another way, the Pratt certificate gives a proof that a number “a” is a primitive root of the multiplicative group (mod p) which, along with the fact that “a” has order p−1, proves that p is a prime.”

At the recipient-side message processing function 24, the tagged message M* is transformed back into the original message M. This can be accompanied by a process for determining a data set associated with the tagged message M* and then executing a process that involves determining whether the tag 30 represents a solution to the computational problem involving the data set that forms part of the message M which is tagged to produce M*. In order to determine whether the tag 30 represents a solution to the computational problem, the computational problem need not be solved. Rather, since the tag 30 is expected to represent the solution to the computational problem involving the very same data set, one need only verify (i.e., check) whether the tag 30 is indeed a solution. This can be done by performing the inverse of the computational problem referred to above, based on the data contained in the tag 30.

In the practical but non-limiting case where the computational problem is factorization of a numerical representation of the original message M (or a portion thereof) into a plurality of prime factors, the solution to the computational problem can be verified by multiplying the allegedly prime factors (contained in the tag 30) that were received, to see if the result is the same as the numerical representation, i.e., the data set that forms part of the tagged message M*. In practice, multiplication is much easier (i.e., computationally simple) than factorization, from which it follows that the burden of demonstrating legitimacy rests with the sender 14, while the question of whether the sender did or did not solve the computational problem at hand (which would be required at a minimum for a demonstration of legitimacy) can be answered in a straightforward manner by the recipient 16.

Of course, the recipient-side message processing function 24, should also verify that the received allegedly prime factors are indeed prime. Example approaches can be derived by one skilled in the art from the polynomial time algorithm described in the following pre-print: M. Agrawal, N. Kayal and N. Saxena, PRIMES is in P, Annals of Mathematics 160 (2004), 781-793. Again, the reader is also referred to Section 2.5 of Andrew Granville, Bulletin of the American Mathematical Society, Vol 42 (2005), pp. 3-38, incorporated by reference herein. Alternatively, one can verify that the received allegedly prime factors are “extremely likely” to be prime via standard number-theoretic techniques. Here “extremely likely” can mean likely with essentially arbitrarily high degrees of confidence although not total certainty. For example, one may contend that an allegedly prime factor is indeed prime with a probability so high that being mistaken is less likely than some other event which would be deemed of insignificant probability (e.g., the recipient being hit by lightning during a 1 hour time period). Note that using such techniques, it is easy to check with a very high probability that a number is prime in a very short amount of CPU time.

As examples in this regard, certain algorithms exist based on the notion of a “witness to compositeness”. The idea is that if one has a number Q which one would like to test for primality, a “witness” W to the compositeness of Q is a number such that g(Q,W) equals some specified value for some easy-to-evaluate function g if Q is composite, while otherwise one remains ignorant as to whether or not Q is composite from the test (see for instance the Solovay-Strassen test and the Miller-Rabin test described in the Handbook of Applied Cryptography, by A. Menezes, P. van Oorschot, and S. Vanstone, CRC Press, 1996, incorporated by reference herein. There are for example choices of g well-known to number theorists such that witnesses to the compositeness of any Q are more or less uniformly distributed below Q, and a randomly chosen number less than Q will be a witness a specified fraction of the time, for example in the case of the Solovay-Strassen test about half the time. The net result is that it is possible to establish with little effort that a number has any desired probability P (where P is less than 100%) of being prime. This is a useful means of checking primality with a good degree of confidence, which in certain embodiments would be sufficient for a message recipient to accept that the required effort was probably (rather than certainly) expended.

In some embodiments, the recipient-side message processing function 24 has prior knowledge of the definition of the computational problem and/or of the definition of the inverse of the computational problem. This prior knowledge could be established in an initialization phase, or by consulting a web site, etc.

In other embodiments, the sender-side message processing function 20 sends the definition of the computational problem (or an indication thereof, such as an index to a table of definitions) to the recipient-side message processing function 24. The definition of the computational problem may thus be part of the tagged message M* as another data element appended alongside the original message M and the tag 30. Alternatively, the definition of the computational problem (or an indication thereof, such as an index to a table of definitions) may be sent to the recipient-side message processing function 24 in an out-of-band fashion, such as in a separate message and/or over a separate communication link, etc.

In still other embodiments, it is not the definition of the computational problem that is sent to the recipient-side message processing function 24, but rather the definition of the inverse of the computational problem. In a practical example, where the definition of the computational problem is “factorize the number in question into its factors”, the definition of the inverse of the computational problem is “multiply the numbers in question to obtain a product”. Other possibilities will occur to those of skill in the art and such possibilities are within the scope of the present invention.

In yet other embodiments, although the definition of the computational problem (or the definition of the inverse of the computational problem) may be known to the recipient-side message processing function 24, there may be a particular manner in which a data set was determined from the original message M for the purposes of subsequently solving the computational problem, and this manner of determining the data set may be signaled from the sender-side message processing function 20 to the recipient-side message processing function 24.

In various embodiments of the present invention, the basic processes described above as being executed by the sender-side message processing function 20 and the recipient-side message processing function 24 are enhanced with features that allow various advantages to be attained under various circumstances. This can be described in terms of a number of “approaches”, labelled 1 through 9.

### Approaches 1 and 2

One of the ideas behind the concept of demonstration of legitimacy using tags is that the sender needs to demonstrate his legitimacy by doing work (i.e. providing a “proof of work”) in an unforgeable manner, which work can be readily checked by the recipient.

The possibility of precomputing (i.e. computing some time prior to use) tags for communications (or alternatively “messages”—unless otherwise specified, we use the terms interchangeably here) is clearly attractive, particularly for instant media, but poses challenges: for example, without knowing ahead of time what message one plans to send and to whom, it is not obvious how the concept of a tag can be applied. Furthermore, if such a tag existed which could be applied to an arbitrary future message, one would have to know that it could not be reused for any other message (or at least not readily, depending on the embodiment); otherwise the utility of tags would be compromised. By “instant media” it is meant media where there is a greater need for “immediacy” or “instantaneity” (or, to use more standard network engineering terminology, where there is greater need for reduced response times or reduced latency)—for example, where a delay of say 5-10 seconds or even less, would in general be unacceptable. Such media include instant messaging (IM), text messaging, Short Message Service (SMS) messages, Voice over Internet Protocol (VoIP) telephony, and so on.

A precomputed tag may, in general, be considered not quite as good a demonstration of legitimacy as one generated for a given message—in the sense that the precomputed tag was not specifically computed solely for a given message to which it is attached. However, for a wide range of applications, a slightly less “specific” but more immediately usable technique (even if significant computational resources were used ahead of time) is clearly of value. We note in passing that the definition of which media are “instant media”—in the sense of short delays not being acceptable—depends to some extent on how a user in fact uses a given medium, and as such the techniques described here can be used for any message whatsoever (i.e. in those media, such as email, which are not generally viewed as “instant media”). Alternatively put, the approaches described herein represent robust extensions of the concept of demonstration of legitimacy using tags which have special applicability to “instant media” as defined above, but in addition are also applicable to other media such as email, where instantaneity or immediacy may be less important.

Discussed herein are two novel approaches to the problem of precomputing tags. The two approaches are not mutually exclusive and can be combined. Recalling that one way to view tag calculation is to do work which is somehow specific to a message, the two approaches basically entail ensuring that there is something specific about a message to be sent in the future, even though the details of that message may not be known in advance. This can be done by appending appropriate ancillary information which ensures that the computation done in order to generate a tag is in some way specific to a message to be sent in the future, even though the details of the content of that message may not be known in advance. In this context, as we shall see in Approach 2, “specific” need not imply “unique”, but simply that there is a dependence on the content of future message which is sufficiently nontrivial as to allow a tag computation to demonstrate with high probability a high degree of legitimacy. Note that ancillary information could potentially include the date, or information such as the share price of a given stock at the most recent close etc.

Another way to think of a precomputed tag in certain embodiments is as a sort of one-time certification stamp which can be affixed to a message which is written at some future time.

The precomputation and the storage of precomputed tags need not be on the actual device that is sending the messages, and the provision of these services, or the means by which other hardware can be used to provide them can itself be a new business.

### Approach 1

In Approach 1, each sender S maintains a list of unique numbers Nᵢ^{S} (called “Unique Identifiers” or UIDs) indexed by i with S a superscript indicating the sender (i.e. S is not an exponent) which they will include as part of future messages. These need not be sequential nor have any particular properties other than a guarantee that they will appear once and only once in the entire history of messages from S (or alternatively in the history of messages from S to a given recipient R). That is, either: (a) for every message i that is ever sent by a given sender S, there must be a unique Nᵢ^{S}; or (b) there must be a unique number N_{R,i}^{S} for every message sent by a given sender S to a given Recipient R. From now on, we will use Nᵢ^{S} for simplicity, knowing though that the two different implementations are possible—that is, we suppress the possible index R for clarity and notational convenience, but note that it could be included in a concrete implementation.

In more detail, in specific embodiments, there could be an agreed upon protocol whereby the recipient knows what ancillary information (in the example below, 1000001) will have formed part of the tag calculation performed by the sender in the first tag-tagged communication received by the recipient from a given sender, and also an agreed upon protocol which allows the recipient to know what the subsequent number will be (for example it could increase by 1 with each message that is sent by a given sender to a given recipient). The agreed upon protocol could include data from the recipient himself (or herself), or instead there could be an agreed-upon algorithm for the generation or acquisition of such data (as opposed to the transmission of the data itself). It could also depend on an entire history of communications, or on the results of earlier communications.

Approach 1 might be susceptible to problems if, for example, a particular message from a given sender to a given recipient goes astray and hence there are gaps in the ancillary numbers—this issue could, however, in turn be dealt with by additional (perhaps automated) communications between the recipient and sender. As discussed above, a different embodiment which avoids this particular issue is to not have the recipient actually worry what the ancillary number is, but to simply have the recipient verify that, for communications received by the recipient, each tag attached by a given sender to a communication has a different ancillary number included. In other words, if a given sender has sent a given recipient two different communications with the same tag—i.e. in certain examples discussed herein, had used the same ancillary number in both communications (assuming the co-ordinates of the recipient and sender remained unchanged)—then the second e-mail will be flagged in some manner and treated accordingly. For example, it could be automatically sent to the “normal Inbox” or sent to the “Junk Inbox” or deleted, etc.

In a simple embodiment of the latter approach discussed in the above paragraph, the sender could for example adopt the approach of starting with a given number—say 1000001—and simply incrementing this ancillary number (by 1, or in any other fashion, possibly depending on other ancillary data—all that matters is that a receiver can verify that each call they receive has a higher number than before—note that if this ordering technique is used, the recipient does not need to maintain a list of all previous numbers received from a sender, but just the most recent one) for every message the sender sends out (irrespective of who the recipient is), thereby guaranteeing that the ancillary numbers attached to different messages sent to a given recipient (and in fact all recipients) are different. Note that the process of precomputing tags and tracking them could for example be easily handled by a plug-in to email client such as Microsoft Outlook—with Outlook having been instructed to precompute 3 or so tags for each new contact when such contact was added, so they would always be available for use when required.

Note that any number of tags could be precomputed, depending on the implementations. So, for example, one could precompute only one tag per contact name, or two tags per contacts name, or a variable number of tags per contact name (with the number being determined by varying means—for example, by how many times one has called a given contact person within a defined period of time) etc. In other implementations, one may for example first wish to compute one tag for everyone in one's communication client (for example, a VoIP-enabled version of Outlook, when and if such an application is developed); then, when this process is complete, one could thereafter compute two tags for everyone and thereafter three and so. The process could be stopped after a certain specified number of tags per contact has been precomputed. The computations can also be done at varying levels of priority: for example, the precomputations (except perhaps for the first one or two tag precomputations for each contact) could be done by using spare computational time—for example, when the computer is idle.

Now, in Approach 1, if sender S plans to communicate at some point in the future with a receiver R, they calculate a tag for a message based on sender, receiver, but in place of the message M that will be sent later (and, in most cases, composed later as well), the computation is done for a message M₁ which is some function of Nᵢ^{S}. One can additionally include other ancillary data in M₁, as described in, e.g., published PCT Patent Application PCT/CA2005/001076 to LegiTime Technologies Inc.

The sender S can now send the tag generated for the message M₁. Before sending, any other text processing—such as further tag computation, encryption, etc.—can be freely applied in any combination and without limitation. Upon receipt, the receiver R:
a) checks that the tag is valid for M₁ (which could include other ancillary data as well), and
b) checks that the Nᵢ^{S} which went into the tag calculation had never been received from sender S before; this requires that each receiver maintains (or has maintained in some way, which could be done by a third party) a list which ensures that the tag will never be accepted more than once from a sender S.

In this simple embodiment of Approach 1, Nᵢ^{S} is set up as ancillary data, and specifies that the tag is essentially generated as a hash from the message M. which tag is though independent of the data which will comprise the actual content of the message M (which actual content will only be created in the future). The uniqueness of the message in the original tag scheme is ensured by making the Nᵢ^{S} unique to each message, but now this is something which needs to be verified by the receiver by checking against a list. Note that this checking could be done by the recipient (usually, a communications device, computer or CPU of the recipient) against a list maintained on the recipient's communication device or computer. Alternatively, this checking against a list could be done by a third-party—for example, the recipient's Internet Service Provider in the case of VoIP communications, email communications, etc. Since the service provider already as a rule maintains a lot of information about the recipient (who is as mentioned a client), including his or her usage of the service provider's systems and resources, maintaining such a list should not pose any difficulties.

In certain specific embodiments, the first message any receiver gets via this approach could be judged as non-spam. However, it is not necessary to make such an assumption.

The numbers Nᵢ^{S} can, in certain implementations without limitation, be chosen entirely by the sender. In general, each number Nᵢ^{S} need not bear any special relationship with i, other than not being repeated as described above. In particular, the numbers need not be sequential or even ordered; in some embodiments, a lack of obvious structure may be desirable with respect to limiting the possibility of attempts to circumvent the generation of genuine tags as intended here and other security issues (for instance, if there is agreement between the sender and recipient concerning what the numbers in Nᵢ^{S} should be and if these numbers are kept secret by the sender and recipient). They can be based on other ancillary information which can be time-sensitive (thereby enforcing a degree of proof as to the time frame within which the calculation of the tag must have taken place, as is further discussed in, for example, published PCT Patent Application PCT/CA2005/001076 to LegiTime Technologies Inc., incorporated by reference herein) and/or could include data which in fact do not exist previous to a certain time. Examples of the latter are publicly verifiable data (such as opening or closing prices of stocks, etc.) or alternatively, information derived from an intended recipient (for example, without limitation, by being extracted from the most recently received message from the recipient, in this way setting up a kind of handshake).

As a concrete example of how this can be implemented, consider the following:

A person (the call originator) wishes to demonstrate the legitimacy of an attempted call to another person (the call recipient). No message is known in advance and thus tag calculations cannot be carried out based on the actual content of the message (or communication). In any event, it may not even be possible or desirable to spend the time or CPU resources in real time (again, by “real time” here we mean the general sense of “about or close (in some sense) to the time the communication is made or initiated”, with the sense being set by the context and requirements of the given application) so it is desirable to define a tag which could be precomputed in the sense described above.

The data available to the call originator are then, for example:

| | |
|---|---|
| 514-962-2309 | (call originator) |
| 617-243-7607 | (call recipient) |
| 1000001 | (ancillary information making up the |
| [in the case of a VoIP call] | UID, as defined above) |

Alternatively one could consider an email (or instant message, or text message, etc.) where a similar situation holds, and the only data available to the sender of a message is:

From: sender sender@somewhere.org (sender's coordinates)
To: recipient recipient@somewhere-else.org (recipient's coordinates)
1000001 (ancillary information making up the UID)
[in the case of an email].

In either of the above cases, with no message existing yet, the UID (here, 1000001) constitutes a piece of ancillary information as discussed above, and the algorithm used to generate the hash from the message in order to generate a tag is now defined so that it does not include the content of the message (i.e. contents of the communications or information to be communicated by the sender to the recipient) at all—which of course must be the case since, given the tag is being precomputed, no message content exists yet.

In certain implementations discussed in the above example, the sender's software program then converts the italicized text above into a binary number using the standard ASCII code, and thereafter creates a computational problem (such as, without limitation, a factoring problem), for example by means of a suitable hash function. The “call originator” or “sender” can anticipate that they will attempt a communication at some time in the future, and thus can begin the tag pre-computation at any time prior to attempting the make or initiate the actual communication. The tag generated in this way, with the hash not including the message (or information to be communicated by the sender to the recipient) at all, is then sent as a demonstration of the legitimacy (tag) associated with the communication. It is specific to both receiver and sender. It is also specific to the overall communication—though, as discussed, independent of the content of the message (information to be communicated) which might in certain embodiments in fact follow as part of the same communication whose legitimacy is being demonstrated (for example, in the case of VoIP communications)—in the sense that the UID is unique to that message and cannot be reused. To ensure this latter point, the recipient maintains a list of UIDs received from each sender and rejects a message from the same sender with a UID which has been seen before. This acceptance or rejection is not dependent on knowing with certainty who really originated the message (and is thus logically independent of “Sender ID”, Sender Policy Framework or other similar approaches which seek to ascertain with certainty who originates a message, and have a number of issues) but only requires that the relevant computational work has been done.

We note that one can readily guard against situations where a spammer tries to circumvent Approach 1 by either simply attaching a very large number as Nᵢ^{S}, confident that this number would not have been used before in a communication between a given sender-recipient combination; or simply choosing the number Nᵢ^{S} at random, hoping that for a significant number of recipient-sender combinations a given Nᵢ^{S} has not been used before. This can be guarded against by ensuring that the numbers used as Nᵢ^{S}'s in a given sender-recipient combination, follow some pre-determined pattern. As an example without limitation, a given embodiment could be such that Nᵢ^{S}'s for a given sender-recipient combination are always incremented by one for each subsequent message; then, in order to deal with potential non-arrival of messages etc., the recipient's client could reject a given Nᵢ^{S} if it differs by more than X (where X could be say 1 or 10) from the Nᵢ^{S} used in the message received by the recipient from the sender immediately prior. (A reason for selecting X to be greater than 1 is to allow for the possibility that occasionally messages go astray and hence are not delivered.)

Communications which fail this test of legitimacy on the receiver end can be flagged in some appropriate manner and treated accordingly (for example, mails or instant messages could be automatically sent to the “normal Inbox” or sent to the “Junk Inbox” or deleted, calls rejected or put on hold, etc.).

Another example of a class of embodiments of Approach 1, containing many of the elements discuss above, is as follows.

The sender S maintains a list of ancillary information (as described above) in the form of numbers called “Unique Identifiers” or UIDs, which he will only ever use once (e.g. the number 1000001 above). As discussed, these can be drawn from any list, either locally generated (possibly even dynamically, through simple incrementing of an initial base number, or via a more complicated algorithm), or from an outside source of data. Additional ancillary data A′ (possibly null, possibly time-dependent, etc.) can also be considered. The combination (<UID>,<S>,<R>,<A′>) is treated as the contents of a message. [Note that here <UID> stands for a number derived from the UID in a well-defined manner (potentially just the number itself), <S> stands for a number derived from the sender's co-ordinates, <R> stands for a number derived from the recipient's co-ordinates, and <A′> stands for a number derived from the ancillary information.]

From this message one then generates a tag, D₁, generated using one of the variety approaches discussed in this specification. At a later time when the sender wishes to send a message (not necessarily conceived at the time that D₁ was generated) to R, D₁ is appended to the message as additional data. This augmented message may be sent as is (or may itself be subject to tag certification or any other processing). The recipient checks D₁ as a proof of work but only accepts it if both a) the tag is valid with valid sender, receiver and A′ (which may be null), and b) he or she has never received a message from that sender with that UID.

This embodiment requires each recipient to maintain a list (essentially something like a dynamically generated blacklist, not for a sender but for a sender+UID combination obtained from received tags), in order to keep track of which UIDs have been used by which sender. In certain embodiments, a first communication will always be accepted if the tag is valid since no previous UID for that sender would have been recorded. (In alternative embodiments, a specific starting number might be required and in yet other embodiments, a specified sequence of subsequent UIDs might also be required from a specific sender.) Additional restrictions could be added such as rejecting a message subject to a check on the ancillary data A′ which could reflect such legitimacy-enhancing gestures as recent computation (e.g. using date-stamping to reject a D₁ generated a very long time ago, such as more than a day ago), other data that could not have been predicted in advance (e.g. closing share price data, weather data at a specified time, etc.), and/or a check that A′ had required some work to obtain (for example was itself a tag for something, or could be confirmed as having been purchased etc.).

Another example of a simple precomputation scheme which embodies elements discussed above is as follows.

In this example, one insists that in precomputed tags the time and date appear and reject (either at the ISP, or recipient level, or indeed anywhere else between the sender and the recipient) all messages which are more than say 24 hours old. This time period could be made significantly longer or shorter, depending on the particularities of the media in question and potentially also on the preferences of users, service providers etc. In addition, one would reject a tag (each of which is a combination of sender information, recipient, information, time and date information, etc., but in this example without any dependence on the content of the message) if it has exactly the same contents (including the same time and date) as a tag which was previously received. [One could alternatively, if one chooses. allow a given set of information in a tag to appear a specified number of times before being automatically rejected.] The sender then has his or her device or service provider precompute for example 5 tags per correspondent (or recipient), refreshing them on a regular basis during CPU downtime or at other times as desired, so that one always has 5 that were generated within for example the last 12 hours. (If one allows a maximum of 12 hours for delivery, then 12 hrs for longest time of tag generation+12 hrs for delivery equals 24 hrs. We note that a 12 hour delivery window may be too long or too short depending on the media involved and other circumstance: in general, one would need to adjust the time periods, in light of real performance data and other considerations). If one's list of correspondents is very large or if otherwise considered desirable, one could instead compute the tags on demand (i.e. when required) if for example the communications being sent are non-urgent (thereby avoiding the need to continually refresh the tags, and hence saving on CPU). Alternatively, one could send communications in such instance without tags (i.e. as “bulk” communications). Alternatively, the sender will need to purchase or otherwise gain access to additional CPUs, if for example the messages are indeed urgent and one's contact database is at the same time very large.

A precomputed tag could contain a sequence of information such as:

| 07012006 | .825891 | 000014 | 875620 | 15142345678 | 17065427962 |
|---|---|---|---|---|---|
| Date of | US → Euro | The number | Random | Sender's | Receiver's |
| creation | exchange rate | of times | six digit | phone | phone |
| | at 12:01 AM | sender has | number | number | number |
| | on that date | called receiver | | | |

as well as the actual derived problem and computation which represents its solution.

With the time information included a recipient can require constraints such as that the date of creation be within some specified time interval (and here we can quantify effort through the proof of “rate of work” whereby work is judged as more significant if it is done in shorter period of time).

Time sensitive date such as the US→Euro exchange rate (or other public time-stamped information) could easily be loaded on every communications device and stored for whatever time period is required (which could be long—i.e. a month, or a time interval no longer than a month, say, with updates done either actively by the sender or automatically when convenient).

Here the “random six digit number” represents any data which is at least in some degree specific to the message which will be sent. It could be some part of the message which it is known ahead of time will be sent such as a greeting, or even a hash of the message (perhaps not yet composed—in which case several tags would have to be generated and only the one with the correct hash would actually turn out to be useful, again demonstrating an addition degree of computational work since all the possible hash values would have to computed with to ensure that the message will go out with a tag; this is treated in more detail in Approach 2 below and elsewhere in this specification).

### Approach 2

Approach 2 is as follows. In general, while one may not know what message one will compose to receiver R in the future, one can make use of a function f₂ which maps all potential messages (plus ancillary information if any) into a limited set of Nₘₐₓ numbers. Now, one can imagine doing work to generate a tag based not on a future message (together with ancillary information if any), but rather based on a number (which we will call a “message ID” or MID, which is in some ways similar to a UID but need not be unique to a given sender or alternatively, given sender-recipient combination) which is the value of f₂ applied to its argument, so that one need only do tag calculations for all Nₘₐₓ numbers ahead of time to be assured of having done the correct one for a specific message. The function f₂ can depend on any subset of sender, receiver, ancillary information (including time-sensitive information as described above), etc. as well as even message content (in the case, for example, of email) which is unknown at the time the tags are precomputed, as long as the dependency on the actual message content M only enters through the value of f₂, which as discussed falls within a limited range, making the precomputation feasible.

In other words, Approach 2 depends on the fact that while one may not know what one will have to calculate in the future in order to attach a valid tag to a given communication, one knows it will be one of Nₘₐₓ values. (In making this assertion, we are assuming in this subsection that for the sake of simplicity that there is a specific known recipient, or, alternatively, that there is no dependency on the recipient's co-ordinates in the tag precomputations; as discussed elsewhere herein, other situations are possible). The only way to be certain to that the necessary calculation for a specific communication will have done ahead of time is to do all Nₘₐₓ calculations, knowing that only 1/Nₘₐₓ is actually going to be useful for a given message.

As a concrete example of how this can be implemented, consider the following: A person (e.g. the call originator) wishes to demonstrate the legitimacy of an attempted call to another person (e.g. the call recipient). The message content is not known in advance and thus tag calculations cannot be carried out based on the message content yet. In any event, it may not even be possible or desirable to spend the time or CPU resources in real time, i.e. at the time the communication is being made or initiated, so it is desired to find a tag which could be precomputed in the sense described above.

The data available to the call originator are then, for example (in the case of a VoIP call):

| | |
|---|---|
| 514-962-2309 | (call originator) |
| 416-243-7607 | (call recipient) |
| data representing the call | (at least a part of the message from |
| | which a tag could be computed) |

The data representing the call can be what we have earlier described as ancillary information without limitation. For example, one could establish that the message to come will have as its start some form of introduction. This could for example be a short burst of information in the form of a brief tone, a spoken message such as “John calling” or “urgent”. This could be intercepted and used to help handle the call and then either made directly audible or not. As a concrete example, I might wish to indicate that the message my phone call is highly urgent and communicate a short text message hoping to stimulate the recipient to accept the call by making more information than just “call from 514-962-2309 coming in”. Note here that underpinning discussions here and elsewhere in the document is the fact that we are talking about electronic communications, as an example VoIP communications, in which any analog signal present (voice in this case) has been digitized and is hence susceptible to the algorithmic processing described herein—for example, having the section of the voice communication (which as discussed, has been digitized) be the basis for a tag computation.

Alternatively one could consider an email (or instant message) where a similar situation holds, and the only data available to the sender of a message is (in the case of an email):

| | |
|---|---|
| From: sender sender@somewhere.org | (sender's coordinates) |
| To: recipient | (recipient's coordinates) |
| recipient@somewhere-else.org | |
| Message body | (at least a part of the |
| | message from which a tag |
| | could be computed) |

In Approach 2, the tag we would compute does not depend on a UID as in Approach 1, but in fact depends on the actual content of the message ahead of time. In order to do this, assume one has a function f₂ chosen to map the originator, sender, and “data representing the call” or “Message body” (in either case possibly together with ancillary information) into one of a set of say 10 numbers—10 MIDs—each of which can now play the role of a UID in Approach 1 above, and from which a tag can be computed. This tag can be computed ahead of time with certainty by simply computing the tag that would be needed for each of the 10 possibilities that could arise. This means that 9 out of the 10 computations would be wasted effort, at least as regards a given communication.

Now on the receiving end, the recipient does not check the tag and the UID against a list (which they now do not need to maintain), but rather checks the tag and that the MID matches the message.

As an example, without limitation, of how Approach 2 could be implemented, assume one had say a set of 100 suitable 14-digit numbers, into which f₂ as defined above maps, factoring all of which would require a significant amount of work. If those numbers furthermore depended on ancillary date-specific information and one required that the tag was generated in the last day, one could be quite sure that the caller had to do quite a lot of work within the past day in order to legitimately and quickly get their message out today. The ancillary information thus can be a part of the message which one is obligated to provide ahead of time (and in this sense that ancillary information could be analogous to the UID defined earlier—with the difference that UIDs are not retired from use but rather time-out after a specified period) or can be based on the first short interval of communications so that failure to have an adequate tag go through would result in a break in communications. In other words, there would be a hang-up or disconnect so that a full communication could not go through and this could happen within a time so short that it would be perceived from the receiver end as a quick hang-up.

An additional example, again without limitation, of an implementation of the technology is to have two layers of “picking up” the phone: the first functioning as a sort of “receptionist” to screen the call for tag certification which could include allowing a limited communication and then, assuming acceptance of the tag, and means to “make the connection” to a human phone user (i.e. recipient). This can clearly be done in a way which is completely seamless to the human phone users.

Further decisions about whether or not to maintain a communication are described as ““Keep me Interested” or “KMI” below.

Of particular concern with both these approaches to tag precomputation is the possibility that outside parties (for example using sniffer programs resident on a Sender's computer) might acquire (i.e. effectively steal the information corresponding to) these precomputed tags and use them. Ways to deal with this include:
1) ensuring that the precomputed tags are stored in a secure fashion (e.g., using encryption, for example);
2) ensuring that the tags will only remain valid for a limited time period by including time dependent ancillary information;
3) including information from the most recent communication received from the recipient (if available), since such information would also have to be obtained to make use of the precomputed tags
4) having the sender send two communications in a row—the first being a communication in which some random (or otherwise unpredictable in advance, such as the recent closing value of a stock index) or pseudo-random text was sent, this text being referenced in the second message via some hash of that message (or the message itself).

In 4) above, an incorrect reference, or no reference at all, in the second message would invalidate the tag attached to the second message—even if the tag was correct from other standpoints. Unless the entity which had acquired the precomputed tags was aware that this process was expected, and the details of how it would be expected to be done, the precomputed tags would not be useful.

A potential drawback of certain implementations of precomputed tags, as regards spam prevention, arises when the recipient's co-ordinates are not included in the tag generation (for example by not being included as input to the hash functions). For a large number of random recipients, many of the hashes calculated in the generation of a precomputed tag (which would have been wasted on a specific person had their coordinates been included) will in fact be valid for someone given a large enough list of recipients, unless the recipient's co-ordinates are included in the tag calculation in a well-defined manner. This can be avoided by ensuring that the number from which the tag is calculated depends on the recipient, as is the case in certain examples provided above.

Should one includes time-sensitive information in either Approach 1 or 2 above, one could ensure that the tags were calculated not too far in the past. This could force ongoing calculation of tags, since tags would time out (i.e. become invalid) after some set interval.

Another example of a class of embodiments of Approach 2, containing many of the elements discussed above, is as follows.

Whatever message one wishes to send at some unknown time in the future, its numerical value—possibly with some preprocessing such as hashing via a function f₂—would be taken “modulo N” (where N some well defined number) before being passed on for tag generation. This means that if N is small enough, and one anticipates sending some number of messages during the day or during some other period, one could have generated a large number of tags which could be used in connection with a message M, with the match to the precomputed tag being made via the following data: (<UID>,<S>,<R>,<A′>,<f₂ (<UID><S><R><A′><M>)mod N>), where any of these fields could be null (or alternatively put, where the specific tag algorithm chosen might not depend explicitly on a specific piece of data, e.g. on <R>, though the dependency on R would in specific embodiments in this case still enter via <f₂ (<UID><S><R><A′><M>)mod N>). For example one might generate tags for nothing other than the co-ordinates of the sender, the co-ordinates of the receiver, and all the N numbers from zero to N−1.

In certain embodiments, one could thus ensure that that the hash function used to generate the tag does not depend directly on the message body (or contents of the message), but rather on just the user, sender and ancillary information described here (with “<f₂ (<UID><S><R><A><M>)mod N>” being viewed as ancillary information). This means that the demonstration of legitimacy could be viewed as having been done on the basis of an effectively null message. Under normal email conditions this might as discussed above possibly be considered a relatively poor demonstration of legitimacy, but for a message sent for example via instant media this might well be satisfactory, especially since the recipient can check that the ancillary information was unique to that message.

In specific embodiments one could explicitly exclude the recipient's information in the tag computation (i.e. ignore “<R>”) though still have dependency on R enter via <f₂ (UID, S, R, A′, M)mod N>) and also assume that <A′> and <UID> are null. In specific embodiments, <f₂ (UID, S, R, A′, M)mod N> is a number between 0 and N−1. tags for all numbers 0, 1, 2, 3, N−1 could then be generated, and while one would have generated N times as many tags as one ultimately needed (if one were only sending one message), one would certainly have generated the correct tag for whatever message would later be included since it only entered into the tag precomputation through its hash to some number from 0 to N−1.

Another example of a class of embodiments of Approach 2, containing many of the elements discuss above, is as follows.

Assume a sender wants to send a recipient a message. The sender wants to show that the message is a) for the recipient, and b) involves some effort on the part of the sender (i.e., has a tag).

In specific embodiments, the sender at the start of some time interval (could be every day, could be every hour, etc.), starts generating tags from that time, and also (in certain embodiments) attaches as ancillary information A′ some unpredictable, but verifiable-by-the-recipient piece of information. This could, for example, be a string (which is, of course, equivalent to a number) provided by, say, the phone company. A′ would in some embodiments be time-dependent.

In certain specific embodiments, the sender starts calculating tags in the following way, where we use the # sign to mean “concatenate the digits”.

0# A′#senderscoordinates
1# A′#senderscoordinates
2# A′#senderscoordinates
. . .
(N−1)# A′#senderscoordinates

Now, if the sender wants to be able too send messages to a recipient without perceptible delays, he sender will hash the whole message, including the recipient's address, into a number from 0 to N−1 which we will call Y and then sends Y# A′#senderscoordinates as a problem along with the precomputed solution, as is discussed elsewhere herein.

What does this mean? It means the sender targeted the tag specifically to the recipient, since the sender based it on Y.

Admittedly the sender also computed other tags which were not used, but the sender computed them all in anticipation of communicating with the sender (or, more specifically, to someone whom the recipient together with the sender's message etc., hashed into Y, by means of f₂).

The recipient's tag is not quite unique, but the recipient's tag is unique up to N. If M is 1000, the recipient's tag is unique up to 1 in 1000.

Another example of a class of embodiments of Approach 2, containing many of the elements discussed above and also illustrating in more detail spam-related issues, is as follows:

Let Y the result of applying f₂ as defined above, and Mₒ stand for all components of a given message—namely (UID₀, S₀, R₀, A₀, M₀). We thus have, as the putative problem to be solved by factorization:

f₂ (M₀)# A′#senderscoordinates

Let's also call the solution to this problem S(M₀).

As discussed above, this approach is problematic in general because spammers who are sending out millions of e-mails will simply attach the number equal to S(M₀) to all messages M which hash to the same number as f₂ (M₀). We thus need to redefine the problem to be:

f₂ (M)# A′#senderscoordinates#receipientscoordinates

Based on this formula there are at least three sub-classes of problems (or scenarios):

i) A′#senderscoordinates#recipientscoordinates (i.e. f₂ is null or trivial)
ii) f₂ (M)# senderscoordinates#recipientscoordinates (i.e. A′ is null or trivial)
iii) f₂ (M)# A′#senderscoordinates#recipientscoordinates, where both f₂ and A′ are non-trivial.

i) This is clearly effective as regards ensuring that a tag cannot be re-used (especially if one, for example, took a number with say 5 digits—e.g. the most recent closing price of the Dow Jones Industrial Average (A′_{RC} for short, with “RC” standing for “most recent closing”)—and in addition added the previous 4 closing prices, say, to the problem, so that the actual problem was:

A′_{Rc}# A′_{RC-1}# A′_{Rc-2}# A′_{Rc-3}# A′_{Rc-4}# A′_{Rc-4}#senderscoordinates#receipientscoordinates
(where A′_{RC-1} was the closing price on the day prior to the most recent day for which one has closing data etc.). Admittedly, it does allow one to send repeated messages on this particular day with this particular tag to this specific recipient, though this is not how spam currently works.

ii) The problem with this scenario is that a given sender can reuse the tags—provided one has computed the tag for a given number k into which M hashes via f2—endlessly for a given recipient (or at least until the co-ordinates of the sender and/or the recipient change). It still obviously constitutes some kind of a barrier to spammers though.

iii) This scenario is obviously the most robust. It protects one, for example, from a situation where spammers start to pool their resources—e.g. share tags—so as to send lots of different spam e-mails on one particular day (as discussed in scenario 1).

Note that the upshot of this analysis is that there are similarities between Approaches 1 and 2. One of the differences is the way in which one ensures re-use of tags cannot occur: in Approach 1, the recipient “retires” ancillary numbers from use, whereas—at least in specific embodiments of Approach 2, such as i and iii above—the date-dependent ancillary numbers ensure that reuse cannot occur (except for the same day in scenario 1).

As a general remark, we note that there might potentially be privacy concerns in some implementations of the above approaches—for example as regards a sniffer program or other program being able to determine all the recipients that have received messages from the sender. In this regard, we note though that in certain implementations (for example, implementations of Approach 2), one does some work ahead of time for all (or some, depending on the implementation) potential contacts in the event one may use one of the tags within a given time-frame—after the expiry of the time-frame, they can all be deleted (including the one or more tags that one in fact ended up using). One can thus remove evidence of the tags used in calls—i.e. delete things in a thorough manner—so that each day (or with some other periodicity) one generates a fresh set of tags. The same sort of strategies can also be implemented in embodiments of Approach 1: in certain implementations discussed above one, for example, one generates a collection of tags ahead of time for some or all people in, say, one's Outlook database who have phone numbers. One could thus have an implementation where these tags are refreshed—i.e. existing tags deleted and fresh ones generated, whether they were used or not—in order to remove traces of which ones were in fact used. Alternatively, or in addition, one can have the UIDs generated according to algorithms which make in impossible to tell on the basis of the UID alone whether this was the n^{th} UID that had been generated for a given contact, or whether it was the first—this coupled with an automatic deletion of tags after use would make it impossible to tell how many times one had called an individual. Note in this context that the recipient in certain embodiments of Approach 1, does not care whether there are gaps in the UIDs—all he cares about is that they are not reused. Also in this regard, we note that one is much more likely to have a bigger issue with people intercepting the actual electronic communications themselves—as opposed to looking for tags on one's communication device which may or may not have been used.

Many of the concerns raised above can also be handled to a large extent by encryption and/or password protection of the relevant computing resources (for protection from sniffer programs, hackers, etc.) and messages (to protect against information being gathered from intercepted communications).

Another general remark relates to the use of approaches discussed within this application to fax transmission. Clearly, the same approaches can be used in this context. Additional variations are also possible with regards to fax transmissions. For example, given that one relatively rarely sends faxes these days, the level of difficulty (or legitimacy score) associated with a tag, could be required to be much higher for a fax transmission than for a phone call. This could help deal with the issue of junk faxes—where in addition to the nuisance factor, one is in a situation where receipt of junk faxes has a very real cost (for example, in terms of the paper that is generally required to print these out and/or the storage space for the graphic image if stored electronically).

It should be appreciated that certain embodiments of the present invention provide the ability for individual users or groups of user to require much higher levels of tags calculations if they so choose, and to vary these levels between communication media (for example, between fax transmission and VoIP calls as discussed above).

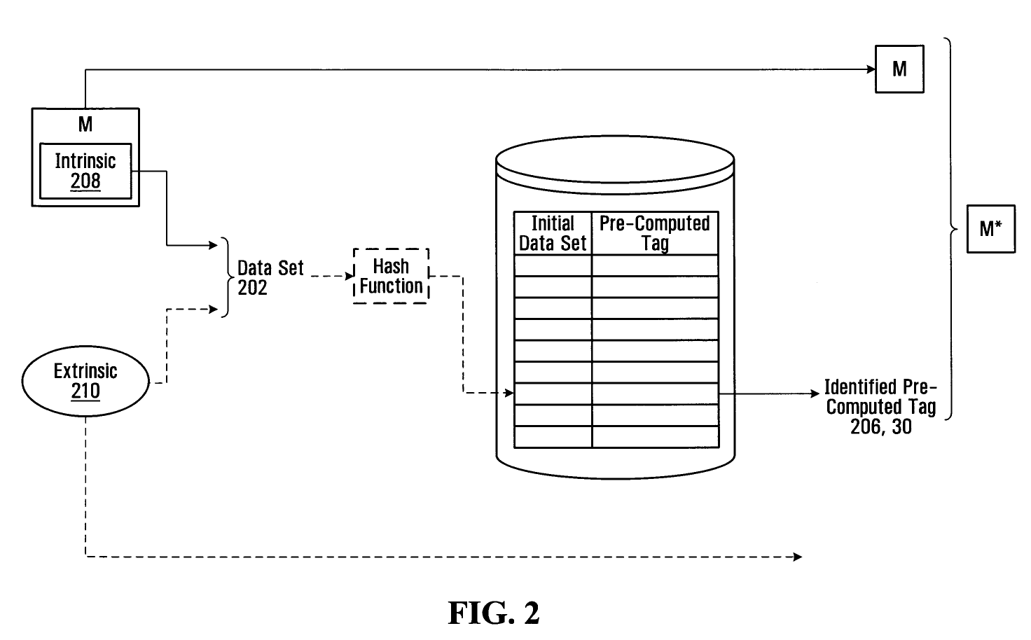

Accordingly, with reference to FIG. 2, the sender-side message processing function 20 executes a method where a data set 202 associated with the original message M is determined. The sender-side message processing function 20 then accesses an ensemble of precomputed tags corresponding to respective initial data sets. This can be done by accessing a database 204, where each precomputed tag in the database 204 represents a solution to a computational problem involving the respective initial data set. Then, the sender-side message processing function 20 identifies one of the precomputed tags in the ensemble (i.e., in the database 204) for which the corresponding initial data set corresponds to the data set 202. Let this precomputed tag (which is one form of the tag 30) be denoted 206. Finally, the sender-side message processing function 20 sends the original message M and informs the recipient 16 of the identified precomputed tag 206. This can be done by appending the identified precomputed tag 206 to the original message M.

The data set 202 may comprise a portion 208 intrinsic to the original message M and a portion 210 extrinsic to the original message M. The data set 202 can be a concatenation of the portion 208 intrinsic to the original message M with the portion 210 extrinsic to the original message M. The portion 208 intrinsic to the original message M may comprise an address of the sender 14, and address of the recipient 16, a time at which the original message M was created, information entered by the sender 14 and forming a body (or content) of the original message M etc. The portion 210 extrinsic to the original message M can impart uniqueness to the data set 202. To this end, the portion 210 extrinsic to the original message M may comprise, without limitation, a data element derived from information previously received from the recipient 16, a reference to a data element sent to the recipient 16 in a previous communication, a sequence number, an output of a pseudo-random number generator at a chronological position that depends on a sequence number, a number of times that the sender 14 has sent a message to the recipient 16, an actual instance of a dynamically varying datum (such as a financial datum) available to the sender and the recipient.

Other examples of the portion 208 intrinsic to the original message M include a portion identifying a sender, a portion identifying a recipient, a portion identifying the title or subject, a portion that comprises a message body, and a portion that comprises file attachments. Other examples of the portion 210 extrinsic to the original message M include spatio-temporal co-ordinates such as, without limitation, time, time zone, geographical location of the sender, or any other information (examples include parameters that are time-dependent in nature and subject to verification, such as a numerical key held by some party, or a publicly available and verifiable datum (for instance an unpredictable one such as the opening price of some stock in some market on some day, etc.) or alternatively some datum, possibly provided by a third party in exchange for consideration as a commercial venture, which is generated by secure, deterministic or random techniques). Such information could be used in order to ensure that a message could not possibly have been generated and subjected to the algorithms which are described herein prior to some given time when this ancillary data did not exist. This in turn can be used to ensure that whatever computational and other resources are brought to bear in order to effect the algorithms described here must be done in the recent past (according to some definition), and could not have been done using slow techniques or low performance computational resources over a long period of time.

In an embodiment, the sender-side message processing function 20 can inform the recipient 16 of the portion 210 extrinsic to the original message M and/or of the portion 208 intrinsic to the original message M and/or of a definition of the computational problem.

Moreover, the sender-side message processing function 20 can apply a hash function to the portion 208 intrinsic to the original message M, to derive thereby a hash value. In such an embodiment, the data set 202 may be composed of (e.g., may be a concatenation of) the hash value and the portion 210 extrinsic to the original message M.

Moreover, and as shown in FIG. 2, the sender-side message processing function 20 can apply a hash function to the portion 210 extrinsic to the original message M and to the portion 208 intrinsic to the original message, thereby to derive a hash value. In such an embodiment, the data set 202 may consist of the hash value itself.

Moreover, generation of the ensemble of precomputed tags from the respective initial data sets can be achieved by generating each precomputed tag by solving the aforementioned computational problem, but involving the respective initial data set. This could involve utilizing CPU cycles to evaluate a computational function of a numerical representation of the respective initial data set. The computational problem involving the respective initial data set could comprise factorization of the respective initial data set into a constituent set of prime factors.

Moreover, the initial data sets in the database 204 could be created from candidate intrinsic data and candidate extrinsic data. Specifically, the initial data sets could be created by creating a plurality of different data sets for which the candidate intrinsic data depend on a common expected message recipient. Alternatively, the initial data sets could be created by creating a number of data sets for which the candidate intrinsic data depend on a common expected message recipient, that number being dependent on the expected message recipient(s).

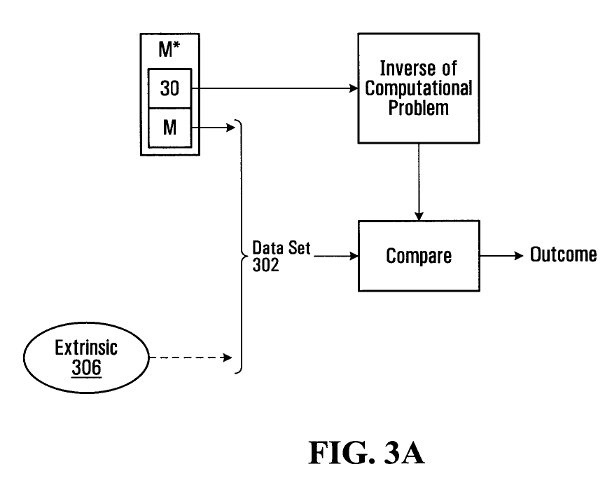

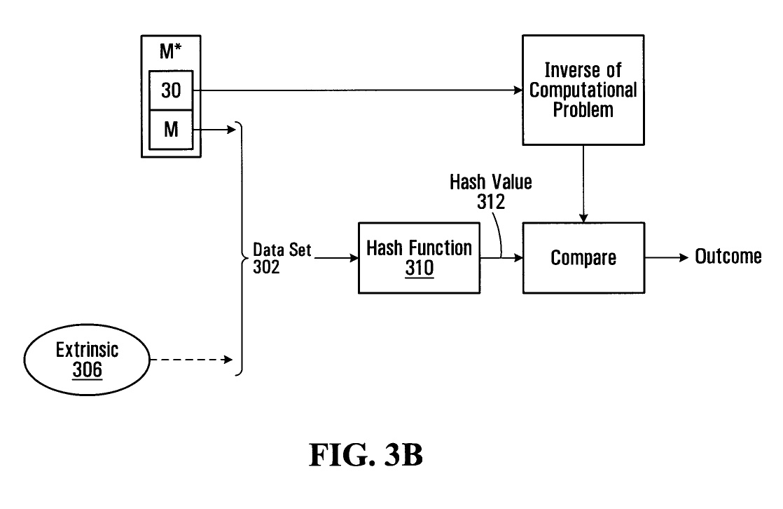

With reference to FIG. 3A, the recipient-side message processing function 24 executes a method where the tagged message M* is received. The tagged message M* contains the tag 30 (which, in the above example, corresponds to the precomputed tag 206). The recipient-side message processing function 24 obtains the tag 30 associated with the tagged message M*. The recipient-side message processing function 24 also determines a data set 302 associated with the tagged message M*. The data set 302 includes a portion 306 extrinsic to the tagged message M* (which, in the above example, corresponds to the portion 210 extrinsic to the original message M). The recipient-side message processing function 24 then proceeds to determine whether the tag 30 represents a solution to a computational problem involving the data set 302. Also, based on the portion 306 extrinsic to the tagged message M*, the recipient-side message processing function 24 determines whether the tag 30 was specifically generated for the tagged message M*. This processing is effected in order to establish a legitimacy of the tagged message M*.

Naturally, it may not even be necessary to determine whether the tag 30 was specifically generated for the tagged message M*, if it is not even true that the tag 30 represents a solution to a computational problem involving the data set 302.

The recipient-side message processing function 24 may gain knowledge of the computational problem from the sender 14 or the sender-side message processing function 20.

In order to determine whether the tag 30 represents a solution to the computational problem involving the data set 302, the recipient-side message processing function 24 can effect the inverse of the computational problem using the tag 30 and comparing the outcome to the data set 302. In the case of prime number factorization, a test for primality may also be applied.

It should be noted that the inverse here, and throughout this document, need not always be unique, and comparison need not necessarily correspond to a simple test of numerical equality. For example, hash functions, by definition, do not have unique inverses. Similarly, as discussed elsewhere herein, some proof of work for the prime factorization of a number N may be demonstrated by providing some (but not all) factors of N, and thereby not providing enough information to reconstruct N unambiguously. In such cases, the “inverse” is in actuality not a single number, but an equivalence class of numbers (“inverses”), and the “comparison” to be performed is not simple equality of two numbers, but rather a test of membership in the equivalence class of “inverses”. In practical terms, such membership can often be achieved more efficiently by repeating the putative forward (i.e. not the inverse) calculation done by the sender and checking to see if the correct answer is generated. For example, suppose f is a many-to-one function, and thus has no unique inverse—a concrete example being to let f(x) be a prime factor of a number x. Now f(10)=5 but f(25) is also 5 as is f(20). If one were given that f(x)=5 and a putative x of 25, one could then check inverses of f which are 5 (three additional examples being 10, 25, and 20) until one found one that was x or one exhausted all candidates. One could also simply check that f(25)=5 thereby demonstrating that 25 is an inverse of 5.)

Alternatively, as shown in FIG. 3B, in order to determine whether the tag 30 represents a solution to the computational problem involving the data set 302, the recipient-side message processing function 24 can apply a hash function 310 to the data set 302, thereby to derive a hash value 312, and effect an inverse of the computational problem using the tag 30 and comparing the outcome to the hash value 312.

Also, in order to determine whether the tag 30 was specifically generated for the tagged message M*, the recipient-side message processing function 24 can obtain comparison data and compare the portion 306 extrinsic to the tagged message M* to the comparison data. The comparison data could comprise portions extrinsic to previously received tagged messages, in which case the tag 30 could be deemed to have been specifically generated for the tagged message M* when the portion 306 extrinsic to the tagged message M* does not correspond to any of the portions extrinsic to previously received messages. In another scenario, the comparison data could comprise either zero or one or more portions extrinsic to previously received tagged messages, in which case the tag 30* could be deemed to have been specifically generated for the tagged message M* either when there are zero portions extrinsic to previously received messages or when the portion 306 extrinsic to the tagged message M* does not correspond to any of the one or more portions extrinsic to previously received messages. Still alternatively, the comparison data could comprise a sequence number, which case the tag 30 could be deemed to have been specifically generated for the tagged message M* when the portion 306 extrinsic to the tagged message M* corresponds to the sequence number. Alternatively still, the comparison data could comprise an output of a pseudo-random number generator, providing an output that depends on a sequence number, in which case the tag 30 could deemed to have been specifically generated for the tagged message M* when the portion 306 extrinsic to the tagged message M* corresponds to the output of a pseudo-random number generator which does not correspond to any of the one or more portions extrinsic to previously received messages. Still alternatively, the comparison data could comprise a number of times that the sender 14 has sent a message to the recipient 16, in which case the tag 30 could be deemed to have been specifically generated for the tagged message M* when the portion 306 extrinsic to the tagged message M* corresponds to the sequence number of times that the sender 14 has sent a message to the recipient 16. Alternatively still, the comparison data could comprise an actual instance of a dynamically varying datum (such as a financial datum), in which case the tag 30 could be deemed to have been specifically generated for the tagged message M* when the portion 306 extrinsic to the tagged message M* corresponds to the actual instance of the dynamically varying datum. Alternatively, the comparison data could comprise a data element derived from information previously sent to the sender 14, in which case the tag 30 could be deemed to have been specifically generated for the tagged message M* when the portion 306 extrinsic to the tagged message M* corresponds to that data element. Alternatively, the comparison data could comprise a data element derived from information received from the sender 14 in a previous communication, in which case the tag 30 could be deemed to have been specifically generated for the tagged message M* when the portion 306 extrinsic to the tagged message M* corresponds to the data element.

The data set 302 could include an indication of a time at which the tagged message M* was created, in which the case recipient-side message processing function 24 could determine staleness of the tag 30 based on comparing the indication to a current time.

If it turns out that the tagged message M* is not legitimate due to a negative outcome in one or more steps, the tagged message M* could be discarded.

### Approach 3

In a first embodiment of Approach 3, any of Approaches 1 and 2 is used and then an additional quick tag calculation is done for an easy problem (“easy” in the sense of readily doable on whatever hardware is at hand), but in real time (i.e. without any perceptible delays). The rationale behind this approach is that a sender can express a extra amount of sincerity by doing a easier calculation now that is specific to all or part of the actual message being communicated, as well as the more difficult calculation the sender did earlier (for example, yesterday) before the sender knew what he or she wanted to say and/or with whom the sender wished to communicate. In the framework of social analogies, the equivalent might be that someone turned up with flowers they had bought yesterday (and perhaps were even for someone else, in certain embodiments) but the extra effort of opening the door for the recipient when the sender meets the recipient, while less of an effort, is an effort nonetheless, and it is at least evident that at that moment the sender is not holding the door open for someone else, since this gesture is very specific to the recipient and the interaction.

In a second realization of Approach 3, any of Approaches 1 and 2 is used and then an additional hard tag (“hard” being defined as “not easy”—the exact criteria for defining the difference between “hard” and “easy” being dependent on context and application) calculation is done, for example by generating a tag for part or all of the actual message M, i.e. by chaining the two different tag calculations together.

In a third realization of Approach 3, tags may be computed for part of a message as it is being created. This may be of particular interest in applications such as SMS. The idea is that as long as part of a message is known (even the date, time, sender, recipient, etc.) this can be taken as part of a message and used to create a tag. As a message is entered, it, or parts of it, can also be used to create tags and these can be sent as is, or chained as described above. In other words, a message which is in the process of being created can be thought of as a sequence of messages, each representing the submessage of the message up to that time, and tags can be created for some or all of these submessages. For example:

Suppose I am tapping in a text message, and it takes about 30 seconds for me to enter it, after 5 seconds I could start working on a tag for the first 5 seconds of message, taking 5 seconds. After 10 seconds I could start working on a tag for the full previous 10 seconds, using a CPU time again of 5 seconds. After 15 seconds, I could start working on a tag for the full previous 15 seconds, and so on . . . by the time I get to the end, I do 5 seconds of work on the whole message and send it off. The net result is that I did 30 seconds of CPU work even though from my point of view (since this was going on as I was composing the message) there was only a 5 second delay between me pushing “send” and the message going out. Instead of generating the tags based on how much time elapses since the start of typing in a message, this could also be done based on any other measure of quantity of the message which has been entered, and in any way without any need that the intervals are uniform. For example, one could generate a tag after 2 (or any number up to 2) characters had been entered, and then again after a further 10 (or any number up to 10) had been entered, and then after a further 2 (or up to 2) had been entered. Of course, time sensitive information can be included in each of the tags generated along the way.

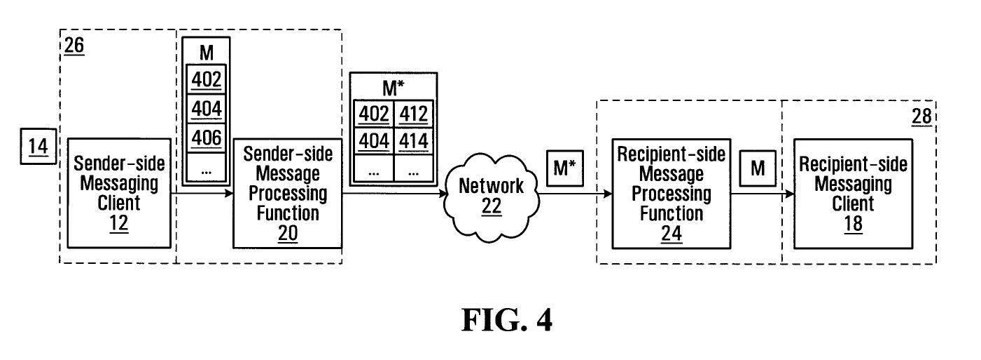

Accordingly, with reference to FIG. 4, the original message M can be broken down into portions 402, 404, 406, each subsequent portion including information that came into existence after the previous portion came into existence. The sender-side message processing function 20 executes a method where a first computational problem involving a first message portion 402, thereby to produce a first tag 412. The sender-side message processing function 20 also solves a second computational problem involving a second message portion 404, thereby to produce a second tag 414. The first message portion 402 and the second message portion 404 are transmitted to the recipient 16, while the recipient 16 is informed of the first tag 412 and the second tag 414. Moreover, the sender-side message processing function 20 may inform the recipient 16 of a definition of the computational problem. Note that while logically 402, 404, 406, etc., each with their tags 412, 414, 416, etc. are depicted as comprising one message, there is no requirement for them to be sent simultaneously (or in fact in any given order), nor is there is any need for any tag to be computed only after any other message portion has come into existence or become available.

In a particular embodiment of the above, the second computational problem could also involve the first message portion 402, so that the solution to the second computational problem is not entirely independent of the solution to the first computational problem. In fact, the second computational problem may also involve the first tag 412.

Moreover, as an example of a concrete implementation, the sender-side message processing function 20 may apply a hash function to the first message portion 402 to derive a hash value, wherein solving the first computational problem comprises factorization of the hash value into a constituent set of prime factors.

### Approach 4

This approach is applicable, for example but without limitation, to streaming applications (via the internet or otherwise), VoIP telephony, etc. As a concrete example, suppose there is data which a sender wishes to have received or viewed. This data could be a phone conversation, streaming video, a pop-up window, or simply the sender could wish that the recipient not get rid of the data [i.e. close the pop-up window (even if it presents unchanging data), hang up the phone, stop watching the video, stop downloading the file, etc.]

Here, the “Keep me Interested” or KMI approach consists of the continuous generation of tags without perceptible or significant delays, so that they can be checked by the recipient. For example, assume the “recipient” is surfing the net and a pop-up window appears. (This appearance is itself a form of communication and can be subject to a tag.) Assume also the recipient's browser has been configured so that it will close the pop-up window automatically, either immediately or within some short time unless it has received instructions to the contrary. The recipient may though opt to allow such pop-ups to stay open if the organization that sent it performs ongoing computational work demonstrating seriousness of intent. The recipient requests or expects (depending on the implementation) a continuous stream of tags which can be based on:
a) precomputed tags generated via Approach 1 above, based on the content itself of the streaming message (viewed now as a sequence of messages with UIDs, all of which messages have to be tag-certified, i.e. correctly tagged) and retired from use by the recipient (or viewer) as discussed above;
b) precomputed tags generated via Approach 2 above, based on the content itself for a streaming message (viewed now as a sequence of messages, all of which have to be tag-certified) subject to hash function f₂; note that, since there may be many such tags communicated in a session, one might insist that the range Nₘₐₓ is large enough to ensure that hash collisions do not occur too frequently;
c) challenges (dynamically chosen or set by some default) from the recipient requesting data which the sender could not possibly know ahead of time, to make sure that they are willing to perform work for the sender to maintain contact; that is to say, the use of specified ancillary information can be insisted upon by the recipient in order to generate the required stream of tags; this ancillary information may be in the form of data which goes into a pre-agreed-upon algorithm for tag generation or could even specify a change in tag generation to keep that recipient happy and receptive to continuing communication; note that such challenges can even be such that the work they represent is actually of use to the recipient, over and above its value as an indication of legitimacy of a communication—in this way a recipient could effectively leverage CPU time of a sender in exchange for remaining receptive to incoming data.
d) conventional tags, as defined in PCT Patent Application PCT/CA2005/001076, simply generated quickly enough to not require that the communications channel over which the continuous message is sent is not slowed down unacceptably.

We note that third parties can provide the stream of tags, having obtained or generated them on behalf of the sender.

Note that this generates an interesting potential revenue stream in that a website (e.g. Google™) could basically certify that it is getting money from someone who wants to keep a pop-up on my screen (in particular). Alternatively put, the idea is to ensure that I have a pop-up window that only comes up (or stays up) if I know the entity originating the data has paid with money or effort to have it displayed on my screen in particular (or to stay open longer than some preset time) and hence presumably wants to communicate with me in particular or is otherwise serious in its intent. The website (or “WebCo”) could additionally enforce certain standards (or not), such as being “free of pornography” or “free of racial slurs”, etc. I could then accept only “WebCo tag-certified” data streams. In addition to my security or comfort about getting “WebCo tag-certified” pop-ups, I could even have a deal with WebCo that some fraction of the revenue generated from their advertisers, etc. comes back to me, or goes to my favourite charity, etc.

The key idea here is that—by using a series of tags as described above—one can provide ongoing demonstrations of proof of work, thereby demonstrating legitimacy.

### Approach 5

There is a growing concern that websites can essentially spam search sites (which we also refer to as “search spam” or “link spam”) or even viewers (see below for more discussion on this latter issue, also referred to as “web spam” herein, which makes it hard for a user to know if a listed site is “serious” or “really offering what it claims to offer”). With regards to search sites, mild versions of this have been around for a while in which spurious keywords are put in a webpage data or metadata in order to make it appear that it has relevant information, but the sophistication behind this manipulation of search results is growing. This continued growth if unchecked could eventually seriously undermine the utility of search sites (such as Google™). LegiTime's technology is in a position to address this issue and related issues which we discuss below.

### Search Spam

In the case of a website which would like to appear on Google™-say, for keywords “computer”, “electronic”, “antivirus”, “Norton”, for example—in response to each request from Google™ as it builds its search index (for instance, a request to a given web-site to send the html code for a given web page for analysis and categorization) the website being queried could provide a tag for the equivalent of a short message—comprising, for example without limitation, each keyword (or link) sent to Google™—as a show of sincerity. In other words, it could demonstrate its legitimacy (or the legitimacy of the links on its pages, see also below) to Google™ via a piece of metadata that gets read by the Google™ crawler as it hits the site. This approach would help for example deal with individuals who create the impression their web-site has many links to it and is hence an “authority” in the eyes of Google™ (thereby warranting a high ranking in the page of search results), by ensuring there was some computational overhead associated with each link.

The above tagging approach could also be combined with an electronic offer to pay a “fee”, which could be cash or an offer computational or other resources etc., i.e. essentially a virtual “check” which Google™ can “pick up” and cash. The variant approach discussed in this paragraph need not conflict with Google™'s standard approach, as they could have this as a separate search option, making two new categories of advanced search options: “Google™ tag-certified” and “Google™ advertising-fee-paid”.

If the standard Google™ search results become much less useful as a result of spam, it will likely gradually fade away in terms of usefulness relative to Google™ searches with the two enhanced options above.

Note by the way that one could also let people download (perhaps at a cost) a tag-generating algorithm, or piece of text to add as “pepper” (any ancillary data added to a message—see PCT Patent Application PCT/CA2005/001076), etc. *from* Google™ (or other web-site) in order to indicate to Google™ that they are offering something Google™-specific to Google™. In more detail, Google™ or others (with Google™'s agreement) could sell software customized to generate a Google™-specific tag (i.e. a tag specific to Google™) so that Google™ sees a link or other piece of data as a message specifically for it (Google™)—this could for example be done at some nontrivial cost of time, since it goes into the preparation of the website (for instance, a website could offer as a tag the solution of a rather spectacularly hard problem which could have taken months to do the work for). In any case, by making sure it is specific to Google™ in some way that Google™ would recognize is a demonstration of legitimacy to Google™—certainly by virtue of computational work being done and perhaps potentially also by virtue of a “fee” having been paid to Google™.

In fact Google™ could make a series of such tag-generating algorithms with varying degrees of computational difficulty and sell them at rates that increased accordingly.

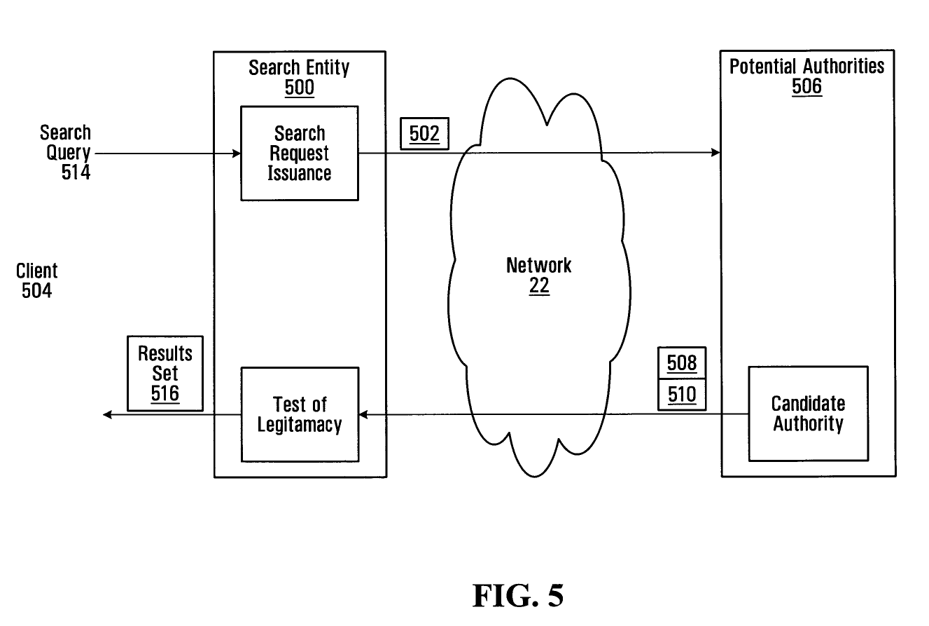

Accordingly, with reference to FIG. 5, a search entity 500 (e.g., an Internet search engine in a non-limiting example) can execute a method whereby a request 502 is formulated based on an actual or prospective search query. In other words, this could occur in a “crawling” phase as the search index is built or when a client has issued an actual search query. (Note that such a query is a form of message and can itself be tagged as can any other, though this possibility is omitted in the figure for simplicity). The request 502 is then issued to a set of potential authorities 506 to identify a subset of “candidate” authorities. (One representative candidate authority is shown in the figure). A candidate authority corresponds to a potential authority in the set of potential authorities 506 that positively responds to the request 502 by supplying a data element 508 and a tag 510 in association with the data element 508. The data elements 508 could be advertisements, key words or actionable web links, for example. Thus, the authorities could be advertisers, general web sites, commercial/corporate web sites, news and other resources, etc. The search entity 500 then establishes legitimacy of the data elements 508 received from one or more candidate authorities based on whether the tag 510 received in association with each particular data element 508 represents a solution to a computational problem involving that data element 508. Finally, a “results set” 516 is presented to a client 504 that has inputted an actual search query 514 (that corresponds to the actual search query, or the prospective search query, on which the request 502 was based), with such “results set” 516 conveying those of the data elements 508 deemed legitimate.

In the above embodiment, the search entity 500 may send a second data element to a subset of the potential authorities, which is then returned as a portion of a data element 508 that is legitimate.

When presenting the results set 516 to the client 504, the search entity 500 may also convey an indication that the data elements 508 presented in the results set 516 are in fact deemed legitimate. Other data elements 508 supplied from potential authorities but which are not deemed legitimate may also be presented in the results set 506, but they may be accompanied by an indication that they are not deemed legitimate (or, alternatively, not known to be legitimate).

In the above embodiment, to establish legitimacy, the search entity 500 may determine whether the tag 510 associated with a particular data element 508 represents a solution to the computational problem involving that data element 508. This can be achieved by effecting an inverse of the computational problem using the tag 510 and comparing the outcome to the data element 508. Alternatively, this can be achieved by applying a hash function to the data element 508, thereby to derive a hash value, and effecting an inverse of the computational problem using the tag 510 and comparing the outcome to the hash value.

The search entity 500 may also send a definition of the computational problem to a subset of the potential authorities, to allow thereby those potential authorities in the subset, when generating data elements in response to requests such as the request 502, to generate tags representing solutions to the computational problem involving those data elements. In this sense, a given potential authority may receive a definition of computational problem unique to itself, while other potential authorities receive definitions of their own respective computational problems. In fact, the definitions of the computational problems can be sold to the potential authorities, at a price that could be commensurate with the level of difficulty or based on other factors.

### Web Spam

In certain implementations of LegiTime's technology, when a browser offers up information (a “message”) of any kind whatsoever, it should tag-certify it (by attaching a tag). Note that every interaction with a website requires that the website know the IP address to which the data will ultimately go. This is tantamount to sending a “message” or “communication” (though not, for example, over the usual SMTP or other mail transfer protocol). In the early, less commercial days of the World-Wide Web, a website offering up information was assumed to have some degree of legitimacy by virtue of the fact that someone made an effort to put up a website and make the information available. Now that untold numbers of websites are out there—for profit or otherwise—it does not seem unreasonable to ask that when one visits an unknown (i.e. “not white-listed”) website for some proof that the information being returned is “legitimate” (in some sense) via a tag. The analogy between frivolous (e.g., porn) websites and spam email is quite strong—the only difference is that the victim of “web spam” (as we call it for short herein) is that the victim did something to get into the state of receiving spam by going to a website (which could have even been indirect in the case of a website re-direct). Note that that many websites can be viewed as high-traffic in some sense, for example for many sites the material one downloads may take seconds to minutes to transfer (for example movies, etc. where there is even a tendency now for people to put up bogus films to try to interfere with people who are trying to get pirated Hollywood material, spread viruses etc.). In these and other contexts an expression of sincerity or legitimacy would be useful. An option is to generate tags without the recipient as part of the input and basically just show a tag on the site which has required a large amount of CPU to generate based on some recent information. Of course with significant resources, this can be done by anyone, but that is the case with other forms of spam (whether electronic or non-electronic) as well. If one, for example, performed a task which each day required 10 CPU-days of time (perhaps run overnight by 20 PCs) this would eradicate annoying users with a single CPU as well as anyone just coming off some ISP-provided webpage which did not have any computing capability at all to make the tags.

In general, one can define two major types of web data (and hence web spam):
1) static web data which is data that remains unchanged for a considerable period of time (e.g. days, weeks, months) but is there without any demonstration of legitimacy having been provided—in terms of time requirements for a tag, this situation would be analogous to email in that long delays (relatively speaking) in generating the requisite tags are fine;
2) dynamic web data which is data that is generated and provided to a specific user in response to specific actions (or continually updated for other reasons); this can include requests for information, pop-ups, etc. and here one might need a way to quickly make a receiver-specific tag and in this context the Approaches 1 and 2 discussed above in the context of instant media are applicable; as an example, one could use Approach 1 (the UID numbers could in certain implementations be tracked via cookies, for example) or potentially use the MIDs of Approach 2.

The line between the two types of data may not always be clearly drawn, and hence one could often have a choice as to which tag techniques to implement.

Note that one can ask for tag certification on entry to a website and then assume the rest is all OK, or one could ask for a tag certification of every page, each time a “click” or other action is taken, or a new piece of data such as a popup is sent, etc.—that is, for each “communication” or “transfer of data” where these terms (“communication” and “transfer of data”) can be defined in any way desired without limitation.

### Click Spam

Another circumstance where tags—whether precomputed or not—could prove of considerable utility relates to situations where one wishes that parties who are performing activities via electronic means (for example, an individual who is clicking on links while surfing the web) demonstrate that they are legitimate, in the sense that they are not performing these activities (e.g. clicking on links) in a spurious or frivolous manner. One simple implementation of the tag technology would entail considering the information being transmitted in response to the above individual's activities (e.g. a web page that is transmitted to the above individual's web browser in response to said individual having clicked on a link) as containing information which is to be the subject of a tag calculation by the above individual (who in this case is the recipient of information which he has requested by clicking on the link). The recipient of this information could then generate a tag for the information received on his computer (this could for example be readily be done by means of a plug-in to the recipient's browser) and the recipient would thereafter send the tag back to the originating web-site (which in this case is the sender), thereby demonstrating to the web-site the legitimacy of the recipient's intent when clicking on the link. One can readily see that this approach could be useful in a number of different situations. As an example, it could address the problem of click-fraud if this approach was generally adopted by those involved in web-advertising. (As an example of a particular embodiment without limitation, if the tag generation engine were included in browsers or otherwise readily available as a plug-in, companies such as Google™ could use this approach to demonstrate to advertisers that the clicks generated were not fraudulent. This is particularly true if the tag thresholds were in fact set very high—for example half an hour or even longer of computation. In this case, one would likely wish to have these tags calculated in the background when there was spare CPU capacity available.) We note that the argument of the computational problem that needs to be solved, in order for the person clicking on the link to generate a tag, need not be the requested web-pages themselves, but could be other forms of data sent by the originating web-site (or alternatively some combination thereof).

Another implementation is to require a demonstration of legitimacy from any requester of information, regardless of whether or not any information had been sent. This follows simply from the realization that any request for information is, in itself, a message, and subject to tagging in order to demonstrate legitimacy.

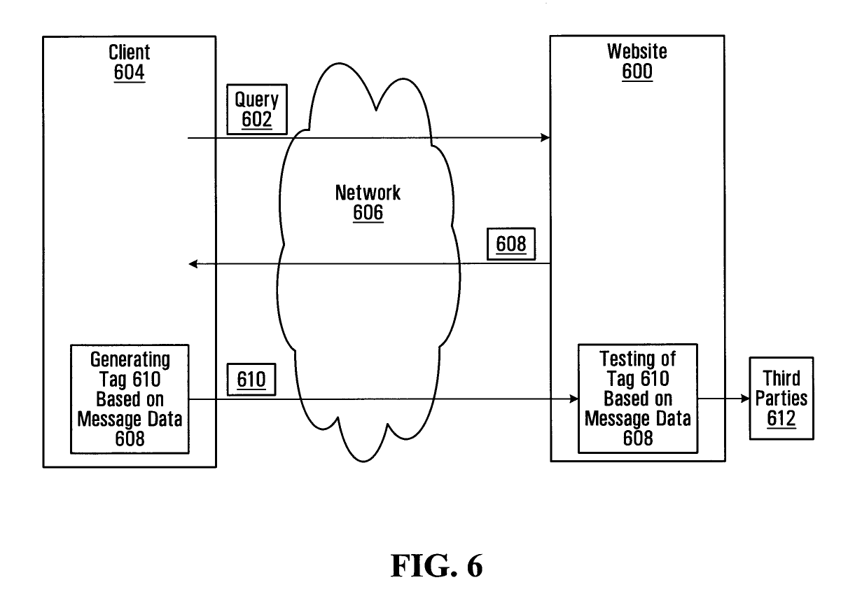

Accordingly, with reference to FIG. 6, a website 600 that implements the recipient-side message processing function 24 can execute a method that comprises receiving a query 602 from a client 604 over a network 606 and then issuing a response 608 to the client 604, with such response 608 including online content. The website 600 is then attentive to receipt of a tag 610 from the client 604, and follows by establishing a legitimacy of the query 602 based on whether the tag 610 subsequently received from the client 604 represents a solution to a computational problem involving a portion of the online content (or alternatively some other information sent to the client 604 by the website 600 at the same time that it sends response 608). Furthermore, the website 600 maintains information on the legitimacy of the query 602 and other queries to which responses including the online content were issued, for conveyance to a third party 612 (e.g., an advertiser or authority of some sort) as evidence of legitimate interest in the online content on the part of the user of a client 604.

In the above embodiment, to establish legitimacy of the query 602, the recipient-side message processing function 24 can determine whether the tag 610 represents a solution to the computational problem involving the portion of the online content. This can be done by effecting an inverse of the computational problem using the tag 610 and comparing the outcome to the portion of the online content (or other information sent to the client 604 by the website 600 at the same time it sends response 608). Alternatively, this can be done by applying a hash function to the portion of the online content (or other information sent to the client 604 by the website 600 at the same time it sends response 608), to derive thereby a hash value, and effecting an inverse of the computational problem using the tag 610 and comparing the outcome to the hash value.

### Approach 6

We also note here that the recipient can be thought of as a person or other entity, rather than a single electronic address, and as such a recipient could be represented by several numbers using for example ASCII code conversions, with said numbers being represented in certain embodiments without limitation as a vector or (X, Y, Z, . . . ) where X, Y, Z etc. are numbers representing different co-ordinates corresponding for example to: a recipient's office telephone number, a recipient's mobile phone number (for SMS messages, calls etc.), a recipient's home-phone number, tone or more email addresses for said recipient etc. This set of numbers, representing multiple different co-ordinates for a given recipient, offers a way to treat all the addresses homogeneously, with tag generation being done for all the different co-ordinates of a given recipient at once. There are many straightforward ways to do this via any function which creates a number which represents a set of numbers. This can be done brute-force by concatenation, or by any other convenient method. Messages could be specifically directed or sent to any of the specific co-ordinates for a given recipient, with a tag calculation being deemed valid if it was computed for a number derived from all of a recipient's different co-ordinates.

Since one tag is generated corresponding to the data representing all the coordinates, and the correct generation of this tag must be checked by the recipient, information about the complete set of coordinates to allow this check to be performed must naturally be in the possession of the recipient and accessible by the recipient-side message processing function. A simple way of ensuring that the sender and the recipient agree as to what the different co-ordinates of the recipient are, is to treat a communication sent to multiple different sets of co-ordinates in the same way as an email that is sent to multiple different email addresses—some of which sets of coordinates could also be on the equivalent of the “cc” line or “bcc” line in an email message, if so chosen. In this manner, the original message M itself contains all the information about the recipients different sets of co-ordinates in the address field, which information is used by the recipient to do the tag checking.

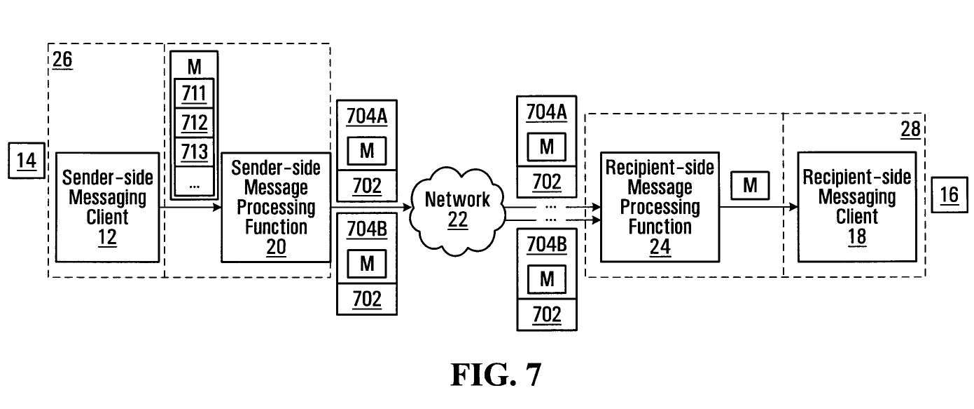

Accordingly, with reference to FIG. 7, the sender-side message processing function 20 can execute a method that comprises obtaining compound address data derived from a plurality of sets of coordinates 711, 712, 713, etc. where the recipient 16 can potentially be reached. The sender-side message processing function 20 proceeds to solve a computational problem involving the compound address data, thereby to produce a tag 702 representing a solution to the computational problem, and then formulates a message 704A (containing an original message M) for transmission to a first one of the plurality of sets of coordinates. In addition, the sender-side message processing function 20 formulates a second message 704B (also containing the original message M) for transmission to a second one of the plurality of sets of coordinates different from the first one of the plurality of sets of coordinates, and also transmits the tag 702 to the recipient 16. (In the alternative, the messages 704A, 704B could be sent in some sequence. For example, depending on whether a receipt had been received by the sender-side message processing function 20 within a specified time frame, which receipt confirmed that the message 704A sent to the first one of the plurality of sets of coordinates had been read, the second message 704B could be sent to the second one of the plurality of sets of coordinates, and so on.) This process is repeated for each of the coordinates to which the original message M is wished to be sent.

At the recipient 16, with continued reference to FIG. 7, the recipient-side message processing function 24 can execute a method that comprises receiving the first or second message 704A, 704B sent to the first or second ones of the plurality of sets of coordinates where the recipient 16 can be reached, followed by obtaining a tag 702 associated with either message. Finally, the recipient-side message processing function 24 establishes a legitimacy of the messages 704A, 704B based on whether the tag 702 represents a solution to a computational problem involving compound address data derived from a plurality of sets of coordinates where the recipient 16 can be reached.

Note that this approach includes all special cases where information concerning any number of coordinates is not included in the generation of tags.

### Approach 7

One could arrange that some or all receivers have a “list of preferred callers”. By this we mean that certain regular communicants could have a “backdoor” by means of which the tag generation is much quicker. This function could be built into device software so that a message recipient could be asked whether he/she wishes to add the caller to the “preferred caller's list”. The private key can be used as ancillary information in order to generate a hash function which depends on that key. The recipient is in possession of that key (since the recipient had given it to the preferred caller earlier) and so can easily verify that the correct hash was provided. This already gives a good degree of confidence that the sender is who they claimed to be and requires very little computational work by the sender—essentially this is a form of sender ID. It involves risk if what was termed a private key ceases to be private, but such keys can be regularly updated to ensure they have limited periods of validity, and computational work can still be required via tasks such as factorization, but could be allowed to be less onerous if there was reason for a receiver to believe that the sender was indeed a preferred caller.

The generation and distribution of private keys for this purpose could be the basis for a new business opportunity.

From the point of view of a caller, the fact that they call a receiver at any point during a day would increase the odds of a subsequent call, and thus motivate the generation of a precomputed tag for that same receiver, or any of a set of receivers which are known to be correlated in the sense that calls to one tend to imply that calls will be made to the others. Such correlation information could be entered directly by a sender into a database, or could be provided by software on the communications device or offline (i.e. Bayesian methods or artificial neural networks could be used). Such data could also be provided by the communications service provider based on actual communications traffic or other data and is the basis for new businesses.

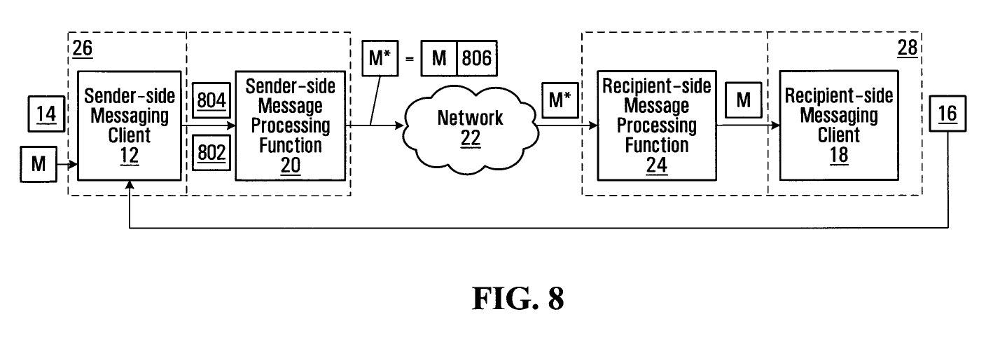

Accordingly, with reference to FIG. 8, the sender-side message processing function 20 is implemented by the sender 14 who is in fact a (first) party that has been designated by a second party (in this case, the recipient 16) as a preferred sender of messages to the second party. The sender-side message processing function 20 executes a method that comprises receiving a preferred sender key 800 and then determining a data set 802 associated with a message M to be sent to the second party. Following this, the sender-side message processing function 20 solves a computational problem involving the preferred sender key 800 and the data set 802 associated with the message M, to produce thereby a tag 806 representative of a solution to the computational problem. Finally, the sender-side message processing function 20 transmits the message M to the second party together with the tag 806.

The preferred sender key 800 can be received from the second party, in this case the recipient 16. Alternatively, the preferred sender key 800 can be received from a service provider, and moreover it may be received from the service provider consequent to transmission of a previous message from the first party to the second party.

At the recipient side, and with reference to FIG. 8, the recipient-side message processing function 24 can implement a method that includes maintaining a preferred sender key 800 that is sent to the sender 14. Then, upon receipt of the tagged message M* from the sender 14, which includes a purported original message and tag, the recipient-side message processing function 24 establishes the legitimacy of the purported original message based on whether the tag represents a solution to a computational problem involving the preferred sender key. Note that the preferred sender key can be sent using any means of secure communications and need not be constant over time.

### Approach 8

A priori there is no way to tell that an initial problem generated from a hash actually corresponds to a useful problem in the sense that it leads to a suitable number (i.e. one which is sufficiently difficult to factor). The fact that there is no a priori way to solve this problem means that solving it is in itself quite a good problem. In other words, the results of each attempt to find a problem (and its solution, in each case rejected as too simple to be ultimately a good demonstration of computational work) is itself a good demonstration of computational work which is easy to verify (requiring only hash computation and the verification that the factors found multiply to the number in question). That is, all the failed attempts along the way to a good problem can themselves be shown as proof of work and constitute a tag. Or in other words, a long list of bad tags generated according to the agreed upon protocol is itself a good tag. This is even the case if after some computational effort has been expended—which would be equivalent to finding one single sufficiently hard problem—has not yielded a sufficiently hard problem. This observation offers then a way to make a more precise estimate of the time that will be expended in the generation of a tag.

### Approach 9

For some purposes, especially mobile communications, it may be advantageous to have shortened tags. Such techniques may also be advantageous if the approach above (Approach 8) is used, which can lead to longer tags with more uniform generation times.

The following 3 points set notation and conventions for the rest of this section:
1) The message M (or whatever subset or superset of it, and with “message” defined in its most general terms, with the option of including any additional ancillary information) must be turned into a number P, which number we will refer to as “the problem”.
2) The problem P is a number derived from the message M by some algorithm, such as a hash function. It is the argument for a mathematical problem, which must be solved, with the solution being the proof that the computational work associated with the problem was done. The solution can in turn, without loss of generality, be represented as a number.
3) The tag is comprised of three key pieces of information:
   a. The problem P
   b. The means by which P was generated
   c. The solution S
   d. The means by which solution S was derived

In one possible implementation, the problem P is a number which is suitably difficult to factor and the solution S is a list of its prime factors, itself represented by a number (for example—given a set of prime factors p1, p2, p3—one can make an ASCII string of these numbers, separated by non-numeric separators such as colons, and then interpret this as a number). Generally, it is important that P itself not be prime (which occurs rarely and results in a trivial problem, but is easy to check), nor should it be the product of a large number of small factors (which also makes the factorization easy since such factors can be found rapidly by trial division). The tag generation application can choose a suitable P by trying repeated hash functions of the message M, with each iteration being indexed by an integer N. Such hash functions we can represent as H(M,N). An example of such an indexed hash function is produced from any other hash function h (such as MD5, SHA1, etc.) by H(M,N)=h(M+f(N)) where f is some 1-1 function of the integers. It can, for example, be any monotone function such as f(N)=N*N+a for some constant a, or simply by the identity function so that f(N)=N. Its nature may be kept as a proprietary secret for any given implementation of tag generation and checking code. We will refer to N later as the “index of the hash function” or “hash index”.

Sequential problems H(M,N) are generated until an N is found for which the problem is deemed suitable (i.e. sufficiently hard) for the given application. By hypothesis, “easy” problems are easy to solve and thus easy to recognize as “easy”, so finding a suitable N is not computationally hard. For completeness, we note that one can allow a “special case” tag to be generated indicating that it was taking too long to come up with a suitable tag so some other approach is taken (perhaps an easier or specially chosen tag). In practice this should be very unlikely, but we do note the possibility and this possible solution.

### Generating Short Tags

Here we wish to consider various techniques which can be used in order to make the actual tag shorter than it would be if: i. the full technique described above is used, and ii. all information described in points 3a,3b, and 3c above is provided.

### 1) Shortening the Description of the List of Primes

Prime numbers are relatively rare, and there are several techniques which can be used to represent a prime number p in less space than a prime number would take if represented in its binary form as an integer. These include:

1.a Shortening the description of each prime. Since all prime numbers greater than two are odd, the last digit of the number must be a one. That means we can represent each prime number of n bits by its first n−1 bits. With this convention, we cannot now represent the prime number “2”, but this is not a serious limitation since the solution can presented as a solution mod 2 (i.e. a solution list of primes is considered acceptable if they multiply to a number which is the problem up to factor of a power of two). Note that this “up to a power of two” is very easy to test numerically either by multiplication by factors of two as needed, or by the equivalent fast operation of bitwise shifts to the left.
1.b Shortening the description of the list of primes by removing some primes from the list. This is an extension of the above suggestion of dropping powers of 2 (which suggestion is also hence included herein). There are some simple and computationally efficient (from the checking side) approaches can be adopted. These are not mutually exclusive:
1.b.i Remove some or all primes smaller than some threshold;
1.b.ii Remove the largest prime factor (or one or more large prime factors, with “large” defined in any way suitable as a compromise between shortening the description of the list and rendering the list so poorly described as to be an unacceptably poor proof of work for the application under consideration);
1.b.iii Remove all factors except the largest prime (or a large prime factor)
1.b.iv Remove prime factors in some other well-defined manner, so that the recipient can independently work out which numbers should have been dropped;
1.b.v Replacing some or all prime factors with compressions or hashes to smaller numbers. This can be done in any standard way including simply sending some digits (in some base) of the prime factor, or some other mathematical information about that number, or any of the standard hash functions, or any other means to send small numbers derived from larger ones, without limitation.

[symbol]

For example, if the problem P were 2*2*3*5*p1*p2*p3 where p1, p2, and p3 are large primes greater than 31, then we would have the following cases:

In case 1.b.i, if the threshold were set at 31, one could just send p1, p2, and p3 and any or none of the factors 2, 2, 3, and 5. On the receiving end it would be fast to reconstruct the factors of 2*2*3*5

In case 1.b.ii, one could send all the factors but for p3 (assuming it was the largest). On the receiving end it would be fast to find P divided by all the sent factors and find the remaining factor. This can then easily be tested to see if it is prime, and can also be tested to see if it was indeed the largest prime factor (if that was required).

In case 1.b.iii, if one sent just the largest prime factor, or a large prime factor, then it would be fast to divide P by that factor leaving a smaller number R as remainder. (Testing that the number sent was indeed prime is easy to test). This in itself would be a good proof that the computational work had been done since the remaining work in factoring R would be small. One could do the remaining work as part of the test and check if the prime sent was indeed the largest (if that was required).

In case 1.b.v, one could replace any of the prime factors with hashes to smaller numbers, for example, some set of selected digits of the numbers (i.e. the first or last N digits for some N, perhaps depending on the size of the prime factor). Note that in some embodiments, this may lead to the sender performing an amount of work to solve the problem that is on the same order as the amount of work performed by the recipient to check the solution to the problem.

### 2) Shortening the Description of the Index of the Hash Function (N Above).

Several possibilities arise here, including:

2.a Hiding N in another parameter in the message. For example, if one can afford to delay a message by some number of seconds between 0 and 59, and one has access to the “seconds” field of that message, then one can use that field to represent any N from 0 to 59. If it is acceptable to have up to 60 seconds of jitter in the accuracy of when the message is sent, one might opt to send a possibly incorrect time (by up to 60 seconds), effectively co-opting the “seconds” field of the time sent to represent the number N. One can alternatively allow fewer iterations and hence ensure a shorter delay by, for example, using the seconds field mod 10 (or mod some other number).
2.b Simply fixing N (possibly to zero) and accepting that sometimes the problem P is not that hard. This requires relaxing the requirements on the difficulty of a tag, but could still provide good tags on average, with the caveat that occasional easy ones might be generated, and that a malicious user might take advantage of this.
2.c Varying N until the first sufficiently difficult P is found. N is now implicitly reconstructable by the tag checking agent from the message M alone, since it is the first N which leads to an acceptable P. This requires tight coordination of the definitions of “acceptable” on the sender and receiver ends, and reduces the degree to which a sender can choose to express a high degree of difficulty through the choice of a hard P, although the size of P alone is a partial measure of that difficulty (at least in a statistical sense).

### 3) Shortening the Description of the Problem P.

Several possibilities arise here, including:

3.a Do not actually send the problem P in the tag at all. The problem P can actually be reconstructed by the tag checking application by two techniques: one, using the hash function which is assumed to be known, and also by multiplying the prime factors of the tag. If these agree, then the problem P will be known to be correct, even though it was not sent. This can be combined with the other approaches described above. For example,
if the approach in 1.a is used as described above, the problem P can be reconstructed mod 2 from the factors and now the agreement in a) immediately above need only be agreement up to a factor of a power of 2;
if the approaches in 1.b are used, one need only check that the putative factors in the solution are indeed factors of P, but now not requiring that they all multiply to make P—n other words some factors can be missing;
as a further refinement, if for example approach 1.b.ii is used, one can divide P by the putative factors and should find that the remainder is either a prime number larger than the other primes that were sent over, or the product of a such a prime number and small primes if one combines 1.b.ii with 1.b.i.

Note that in any case where one asks for agreement modulo some factors (i.e. 2, small primes, etc.) rather than exact agreement, one slightly weakens the tag algorithm. In many cases, however, this would arguably be a small effect.

3.b Simply apply standard compression algorithms to the tag specification, or any part thereof. This can be done on a tag as originally defined, or on any shortened form of the tag as described above. If one is dealing with a tag specified by characters from a limited alphabet (i.e. digits from some base and separators) then one can envision efficient compression algorithms (variants of the standard ones) specialized to take this information into account.
3.c Replace the hash of the message with a shorter (though non-unique) image under another hash function whose output takes up less space. This involves some loss of security since one no longer checks that the problem to be solved was correct, but merely that it hashes to the correct (smaller) value, but in some circumstances this may be an acceptable reduction in security.

### A 16-Bit Example

The techniques described above are all applicable in a very general sense, and what choice is made in any specific implementation is a design decision. That being said, the following is an example of a very rapid tag generation and checking technique which could be used to fit a tag into 16 bits.

Generation:
a) Take the SMS message and generate a problem P of whatever size is desired, with no indexing (i.e. there is no variable N).
b) If P is prime, already (a rare occurrence) send zero as the tag.
c) If P is not prime, factorize it and find the largest prime factor p that will fit in 16 bits (possibly using the trick of sending (p−1)/2). Send that factor p as the tag. (The checking agent must know which was done.) Statistically one expects that p will be much shorter than P.

Checking:
a) Generate the problem P, in the same way as the sender did (note that the details of this can be kept secret, for example within the black-box tagging engine).
b) If P is prime (which is easy to check), then the tag must be zero.
c) If P is not prime, then:
   a. Reconstruct p (trivial if p itself was sent, simple if (p−1)/2 was sent).
   b. Check that p is prime. If not, then the tag is invalid.
   c. Divide P by p. If there is a remainder, then p was not a factor, so the tag is bad. If there is no remainder, then p was a factor, so the tag may be acceptable.
   d. If desired, to further check the tag, see if the prime factor was indeed the largest that would fit in 16 bits. To do this, factorize P/p (this should be easier), or at least work that problem long enough to be convinced that that problem is hard.

If desired, the tag can be compressed before sending, and decompressed on the receiving end. Note that in each case, the tag is just one number, 16 bits long, with no need for separator fields.

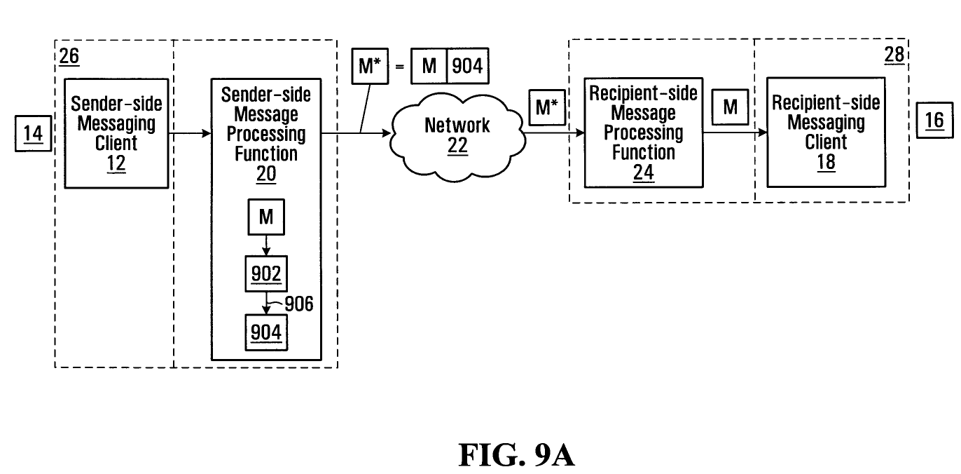

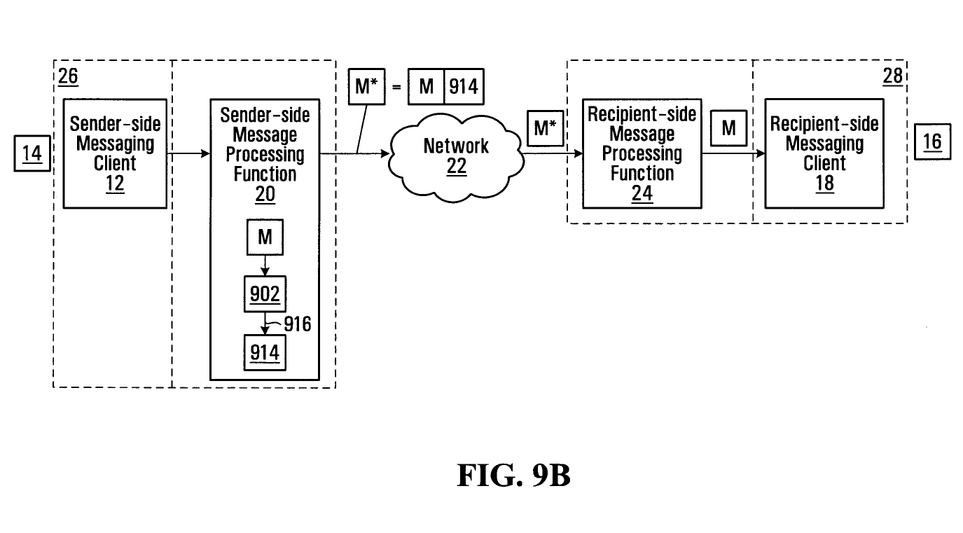

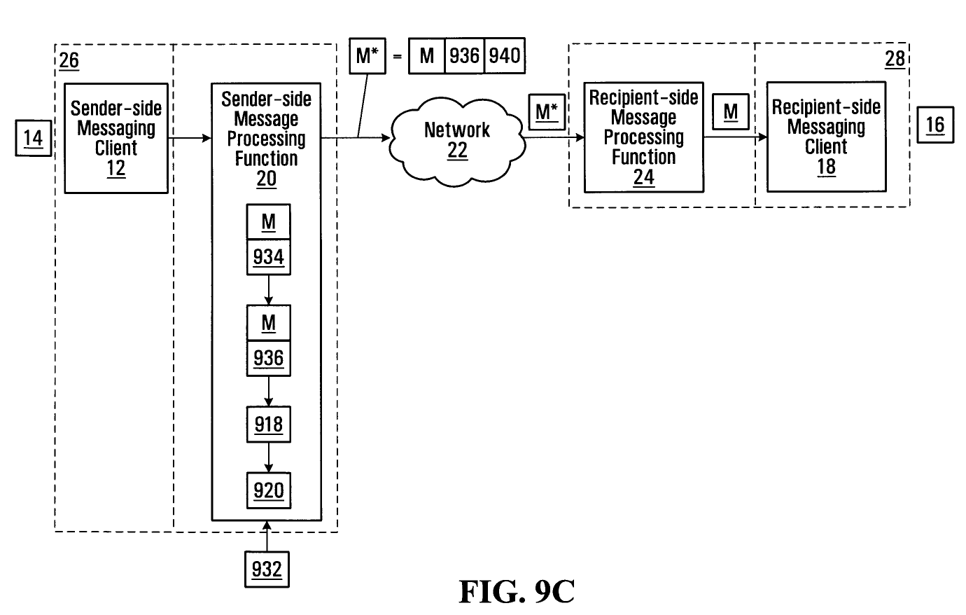

Accordingly, and with reference to FIG. 9A, the sender-side message processing function 20 can implement a method that begins by determining a data set 902 associated with the original message M in any of the previously described ways. The sender-side message processing function 20 then effects a partial factorization function 906 to partially factorize a numerical representation of the data set 902 in an attempt to produce a set {p}ₚₐᵣₜᵢₐₗ of at least one prime factor larger than a certain minimum threshold, each having the property that it (they) is (are) not the largest prime factor. That is to say, dividing the aforesaid numerical representation by the at least one prime factor in the set {p}ₚₐᵣₜᵢₐₗ yields a result that is known or deemed to be factorizable into at least one other prime factor larger than any of the at least one large prime factor {p}ₚₐᵣₜᵢₐₗ. This knowledge (i.e., of the existence of an even larger prime factor) can be obtained by performing the complete factorization or based on another technique. The set {P}ₚₐᵣₜᵢₐₗ can form the tag 904, which is transmitted to the recipient 16 along with the original message M as the tagged message M*. However, the at least one other (i.e., larger) prime factor is (are) withheld and are not transmitted in order to reduce the size of the tag 904. The above approach still permits the application of a hash function to a portion of the original message M to derive a hash value, which then serves as part of the data set 902. We note that if the set {p}ₚₐᵣₜᵢₐₗ is empty, then one would need to vary N.

In another embodiment, with reference to FIG. 9B, once the aforementioned data set 902 is derived, a complete factorization function 916 can be applied to a numerical representation of the data set 902, thereby to produce the complete set of (prime) factors, denoted {p}ₚᵤₗₗ. Then, one or more of the factors in the set {p}_{full}, but not the entire set, is transmitted to the recipient 16 as a tag 914, together with the original message M. The factors that are sent could include the largest such factors that is less than or equal to a pre-defined threshold, such as a power of two. On the other hand, the one or more factors that is (are) withheld could be the one (or those) that is (are) less than this or another threshold. Alternatively, the largest prime factor could be omitted from transmission.

In yet another embodiment, the aforementioned data set 902 is derived and the complete factorization function 916 can be applied to the numerical representation of the data set 902 to produce the complete set of (prime) factors 918, denoted {P}_{full}. In this embodiment, at least one of the factors is then truncated to produce corresponding truncated list of factors 920. The original message M and the truncated factors are then sent to the recipient 16. In the above embodiment, truncation may involve removing a subset of the bits (e.g., the least significant bit) of one, some, or all of at least one of the factors that is greater than two. This can be useful since all prime numbers except the number 2 are odd and the least significant bit is effectively an odd/even bit. Alternatively, truncation may also involve keeping some of the bits (e.g., the first N bits, where N is greater than or equal to unity) of some of the factors that are greater than two, and discarding the remaining bits.

In a further embodiment, with reference to FIG. 9C, the sender-side message processing function 20 can implement a method that begins by selecting a hash function from a set (e.g., a database 932) of candidate hash functions, and then effectively co-opting (i.e., using for a purpose other than the original purpose) a field of the original message M (such as the time field 934) to include an indication 936 of the selected hash function. Thus, instead of showing the actual time, the time field 934 will provide the indication 936 of the selected hash function. The selected hash function is then applied to the original message M modified to include the co-opted field, in order to derive a hash value 938. Then, the sender-side message processing function 20 evaluates a computational function of the hash value 938, thus producing a tag 940 representing a result of the computational function. The original message M modified to include the co-opted field, as well as the tag 940, are then sent to the recipient 16 in the form of the tagged message M*. The recipient 16 may be informed of which field of the tagged message M* had been co-opted to include the indication 936 of the selected hash function. In the above embodiment, the selected hash function could be associated with an index (e.g., of the aforesaid database 932 of candidate hash functions), and wherein the description of the selected hash function includes that index. The sender-side message processing function 20 can of course also inform the recipient-side message processing function 24 of the computational function. Additional computational work may also be included in the tag, and/or associated with the computation of the hash function.

Non-limiting embodiments of the present invention provide methods of processing a message. Certain ones of these methods may be performed, at least in part, by a computing apparatus such as a computer. The computer has a processing entity communicatively coupled to a first memory, a second memory, an input and an output. The processing entity may include one or more processors for processing computer-executable instructions and data. It will be understood by those of ordinary skill in the art that the computer may also include other components. Also, it should be appreciated that the computer may communicate with other apparatuses and systems over a network.

The first memory can be an electronic storage comprising a computer-readable medium for storing computer-executable instructions and/or data. The first memory is readily accessible by the processing entity at runtime and may include a random access memory (RAM) for storing computer-executable instructions and data at runtime. The second memory can be an electronic storage comprising a computer-readable medium for storing computer-executable instructions and/or data. The second memory may include persistent storage memory for storing computer-executable instructions and data permanently, typically in the form of electronic files.

The input may be used to receive input from a user. The input may include one or more input devices, examples of which include but are not limited to a keyboard, a mouse, a microphone, a computer-readable medium such as a removable memory as well as any requisite device for accessing such medium. The input devices may be locally or remotely connected to the processing entity, either physically or by way of a communication connection.

The output may include one or more output devices, which may include a display device, such as a screen/monitor. Other examples of output devices include, without limitation, a printer, a speaker, as well as a computer-writable medium and any requisite device for writing to such medium. The output devices may be locally or remotely connected to processing entity, either physically or by way of a communication connection.

When the processing entity executes computer-executable instructions stored by one or more of the memories, the computer can be caused to carry out one or more of the methods described herein. As can be appreciated, certain ones of the methods described herein may also be carried out using a hardware device having circuits for performing one or more of the calculations or functions described herein.

While specific embodiments of the present invention have been described and illustrated, it will be apparent to those skilled in the art that numerous modifications and variations can be made without departing from the scope of the invention as defined in the appended claims.

1. A method for sending a message to a recipient, comprising:
determining a data set associated with the message;
accessing an ensemble of precomputed tags corresponding to respective initial data sets, each precomputed tag representing a solution to a computational problem involving the respective initial data set;
identifying the precomputed tag in said ensemble for which the corresponding initial data set corresponds to the data set associated with the message; and
sending the message and informing the recipient of the identified precomputed tag.

2. The method defined in claim 1, wherein the data set associated with the message comprises a portion intrinsic to the message and a portion extrinsic to the message.

3-17. (canceled)

18. The method defined in claim 1, further comprising applying a hash function to a portion intrinsic to the message, thereby to derive a hash value.

19. The method defined in claim 18, wherein the data set associated with the message comprises the hash value and a portion extrinsic to the message.

20-32. (canceled)

33. The method defined in claim 1, further comprising applying a hash function to a portion extrinsic to the message and to a portion intrinsic to the message, thereby to derive a hash value.

34. The method defined in claim 33, wherein the data set associated with the message comprises the hash value.

35-37. (canceled)

38. The method defined in claim 34, wherein the portion intrinsic to the message comprises information entered by a user and forming a body of the message.

39. The method defined in claim 38, wherein the portion extrinsic to the message comprises a sequence number.

40. The method defined in claim 38, wherein the portion extrinsic to the message comprises an output of a pseudo-random number generator at a chronological position that depends on a sequence number.

41. The method defined in claim 38, wherein the portion extrinsic to the message comprises a number of times that the sender has sent a message to the recipient.

42. The method defined in claim 38, wherein the portion extrinsic to the message comprises an actual instance of a dynamically varying datum available to the sender and the recipient.

43. (canceled)

44. The method defined in claim 38, wherein the portion extrinsic to the message comprises a data element derived from information previously received from the recipient.

45. The method defined in claim 38, wherein the portion extrinsic to the message comprises a reference to a data element sent to the recipient in a previous communication.

46. The method defined in claim 38, wherein the portion extrinsic to the message imparts uniqueness to the data set associated with the message.

47. The method defined in claim 1, further comprising generating said ensemble of precomputed tags from the respective initial data sets.

48. The method defined in claim 47, wherein said generating comprises generating each precomputed tag in said ensemble by solving the computational problem involving the respective initial data set.

49. The method defined in claim 48, wherein solving a computational problem involving the respective initial data set comprises utilizing CPU cycles to evaluate a computational function of a numerical representation of the respective initial data set.

50. The method defined in claim 48, wherein the computational problem involving the respective initial data set comprises factorization of the respective initial data set into a constituent set of prime factors.

51-59. (canceled)

60. Apparatus for sending a message to a recipient, comprising:
means for determining a data set associated with the message;
means for accessing an ensemble of precomputed tags corresponding to respective initial data sets, each precomputed tag representing a solution to a computational problem involving the respective initial data set;
means for identifying the precomputed tag in said ensemble for which the corresponding initial data set corresponds to the data set associated with the message; and
means for sending the message and informing the recipient of the identified precomputed tag.

61. A computer-readable medium comprising computer-readable program code which, when interpreted by a computing apparatus, causes the computing apparatus to execute a method for sending a message to a recipient, the computer-readable program code comprising:
first computer-readable program code for causing the computing apparatus to determine a data set associated with the message;
second computer-readable program code for causing the computing apparatus to access an ensemble of precomputed tags corresponding to respective initial data sets, each precomputed tag representing a solution to a computational problem involving the respective initial data set;
third computer-readable program code for causing the computing apparatus to identify the precomputed tag in said ensemble for which the corresponding initial data set corresponds to the data set associated with the message; and
fourth computer-readable program code for causing the computing apparatus to send the message and inform the recipient of the identified precomputed tag.

62-205. (canceled)
